(19) United States
(12) Patent Application Publication
(10) Pub. No.: US 2005/0060070 A1
(43) Pub. Date: Mar. 17, 2005

(54) Wireless communication framework

(75) Inventors: Michael Kapolka, Sterling Heights, MI (US); Sam Chang, West Bloomfield, MI (US); Andrew Smith, Cedar Rapids, IA (US); Brian Crull, Oak Park, MI (US); Dennis Essenmacher, Royal Oak, MI (US); Andrew Ditchfield, New Hudson, MI (US); William Bromley, Lapeer, MI (US); Brian Carl, Rochester Hills, MI (US); Gregory A. Dils, Tiffin, IA (US); Hassanayn Machlab El-Hajj, Coralville, IA (US); Gregory J. Kelsey, Cedar Rapids, IA (US); Mark Brown, Iowa City, IA (US); Nik Neymeyer, Marion, IA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NNT, Inc., Sterling Heights, MI (US)

(21) Appl. No.: 10/823,804

(22) Filed: Apr. 12, 2004

Related U.S. Application Data
(63) Continuation-in-part of application No. 10/091,096, filed on Mar. 4, 2002.
(63) Continuation-in-part of application No. 09/640,785, filed on Aug. 18, 2000.
(60) Provisional application No. 60/351,165, filed on Jan. 23, 2002.
(60) Provisional application No. 60/462,561, filed on Apr. 11, 2003.
(60) Provisional application No. 60/462,583, filed on Apr. 11, 2003.
(60) Provisional application No. 60/462,582, filed on Apr. 11, 2003.

(51) Int. Cl. G06F 19/00

(52) U.S. Cl. 701/29; 701/33; 340/438

(57) ABSTRACT

A system, method, and computer program product is provided for remote vehicle diagnostics, telematics, monitoring, configuring, and reprogramming. The system includes an on-board unit disposed on at least one vehicle, an application-service-provider infrastructure, and an interface. The on-board unit is operable to send and receive data corresponding to at least one vehicle operating characteristic. Located on the application-service-provider infrastructure is an application suite. The application suite includes at least one modular application each of which has an associated function that processes said data obtained via the on-board unit. The interface is operable to select from the application suite at least one of the modular applications that will use the associated function to diagnose, monitor, configure, reprogram, and/or obtain telematic information from the at least one vehicle.

### REFERENCE TO RELATED APPLICATIONS

The present application is a continuation-in-part, claiming the benefit of commonly assigned, co-pending U.S. patent application Ser. No. 10/091,096, filed Mar. 4, 2002, entitled “Remote Monitoring, Configuring, Programming and Diagnostic System and Method for Vehicles and Vehicle Components,” which claims the benefit of U.S. Provisional Application No. 60/351,165, entitled “Wireless Communication Framework”, filed Jan. 23, 2002, and is a continuation-in-part, claiming the benefit of commonly assigned, co-pending U.S. patent application Ser. No. 09/640,785, filed Aug. 18, 2000, entitled “System, Method and Computer Program Product for Remote Vehicle Diagnostics, Monitoring, Configuring and Reprogramming,” the disclosures of which are incorporated by reference in their entirety.

The present application also claims the benefit of (i) U.S. Provisional Patent App. Ser. No. 60/462,561, filed Apr. 11, 2003, entitled “System, Method and Computer Program Product for Remote Vehicle Diagnostics, Telematics, Monitoring, Configuring, and Reprogramming,” (ii) U.S. Provisional Application No. 60/462,582, entitled “Wireless Communication Framework”, filed Apr. 11, 2003, and (iii) U.S. Provisional Application No. 60/462,583, entitled “Vehicle Interactive System”, filed Apr. 11, 2003, the disclosures of which are incorporated by reference in their entirety.

The following related applications are hereby incorporated herein by reference in their entirety:
U.S. Provisional Application No. 60/354,673, filed Feb. 5, 2002, entitled “Vehicle-Interactive System,”;
U.S. Utility application Ser. No. 10/358,637, filed Feb. 5, 2003, entitled “Vehicle-Interactive System,”;
U.S. Utility application Ser. No. 10/084,800, filed Feb. 27, 2002, entitled “Vehicle Telemetry System and Method,”;
U.S. Utility application Ser. No. 10/084,800, filed Feb. 27, 2002, entitled “Vehicle Telemetry System and Method,”;
U.S. Utility application Ser. No. 10/229,757, filed Aug. 28, 2002, entitled “Remote Vehicle Security System,”;
U.S. Utility application Ser. No. ______ (Attorney Docket No. 03-078-A1), entitled “Wireless Communication Framework,” filed concurrently herewith; and
U.S. Utility Application No. ______ (Attorney Docket No. 03-050-E), entitled “Vehicle Interactive System,” filed concurrently herewith.

### BACKGROUND

1. Technical Field

The disclosed system, method, and apparatus relate generally to the field of computer data and information systems, and more particularly to computer tools for storing, processing, and displaying vehicle information.

2. Description of Related Art

It is common for companies to own a large number, or fleet, of commercial motor vehicles. Typical examples of such companies include commercial courier services, moving companies, freight and trucking companies, truck leasing companies, as well as passenger vehicle leasing companies and passenger carriers. To maintain profitability, a company owning a vehicle fleet ideally minimizes the time spent in vehicle maintenance and repair. Maintaining optimum vehicle performance often involves removing vehicles from service to conduct fault analysis, scheduled maintenance, diagnostics monitoring and parameter modifications.

Further, companies that manufacture vehicle components may wish to have a central database to access information for product improvements, warranty service, diagnostics, and other component data after components have been installed on the vehicle. Because different companies and different industries have different vehicle-data gathering and reporting needs, current solutions involve constructing specialized systems for each particular user application.

There is a desire for a system that can monitor, configure, program and diagnose vehicles and/or vehicle components while accommodating the different needs of different users and different industries.

### SUMMARY

Accordingly, one embodiment provides a system for remote vehicle diagnostics, telematics, monitoring, configuring, and reprogramming, comprising an on-board unit disposed on at least one vehicle to send and receive data corresponding to at least one vehicle operating characteristic; an application-service-provider infrastructure; an application suite located on the application-service-provider infrastructure, comprising at least one modular application, each of the at least one modular applications having an associated function that processes said data obtained via the on-board unit; and an interface for selecting from the application suite at least one of the modular applications that will use the associated function to diagnose, monitor, configure, reprogram, and/or obtain telematic information from the at least one vehicle.

Another embodiment provides a method for remote vehicle diagnostics, telematics, monitoring, configuring, and reprogramming, comprising: obtaining data from an on-board unit disposed on at least one vehicle corresponding to at least one vehicle operating characteristic; providing an application-service-provider infrastructure; providing an application suite located on the application-service-provider infrastructure, comprising at least one modular application, wherein each of the at least one modular applications has an associated function that processes said data obtained via the on-board unit; and selecting, via an interface, at least one of the modular applications from the application suite to process, using the associated function, the data obtained from the on-board unit to diagnose, monitor, configure, reprogram, and/or obtain telematic information from the at least one vehicle.

Another embodiment provides a computer program product comprising a computer usable medium having control logic stored therein for causing a computer to provide remote vehicle diagnostics, telematics, monitoring, configuring, and reprogramming, comprising: first computer readable program code means for causing an on-board unit disposed on at least one vehicle to send and receive data corresponding to at least one vehicle operating characteristic; second computer readable program code means for providing an application suite located on an application-service-provider infrastructure, comprising at least one modular application, each of the at least one modular applications having an associated function that processes said data obtained via the on-board unit; and third computer readable program code means for providing an interface for selecting from the application suite at least one of the modular applications that will use the associated function to diagnose, monitor, configure, reprogram, and/or obtain telematic information from the at least one vehicle.

Further embodiments and variations will be apparent from the drawings and description below.

### BRIEF DESCRIPTION OF THE DRAWINGS

Exemplary embodiments are described below in conjunction with the appended drawing figures, wherein like reference numerals refer to like elements in the various figures, and wherein

FIG. 1 is a first block diagram illustrating an overall system according to one embodiment;

FIG. 2 is a second block diagram illustrating a system architecture according to one embodiment;

FIGS. 3A and 3B are third and fourth block diagrams illustrating one embodiment of an on-board unit in one embodiment;

FIG. 4 is a fifth block diagram illustrating a parameter retrieval process according to one embodiment;

FIG. 5 is a sixth block diagram illustrating a parameter retrieval process according to another embodiment;

FIG. 6 is a seventh block diagram illustrating a parameter retrieval process according to yet another embodiment;

FIG. 7 is a graph illustrating an operation of a threshold alert process according to one embodiment;

FIG. 8 is an eighth block diagram illustrating the operation of a tamper alert process according to one embodiment;

FIG. 9 is a ninth block diagram illustrating a parameter change process according to one embodiment;

FIG. 9A is a tenth block diagram illustrating an exemplary application suite that may be employed in connection with one embodiment;

FIG. 10 is an eleventh block diagram illustrating a first application architecture for a remote diagnostics application to be used in one embodiment;

FIG. 11 is a twelfth block diagram illustrating a second application architecture for a leased vehicle management application that may be used in one embodiment.

FIG. 12 is a first flowchart illustrating a process flow for an application task according to one embodiment;

FIG. 13 is a second flowchart illustrating a process flow for an application task according to one embodiment; and

FIG. 14 is a third flowchart illustrating a process flow for an application according to one embodiment.

### DETAILED DESCRIPTION OF THE EMBODIMENTS

1. System Functionalities and Architecture

a. Overview

A system, method and computer program product for remote vehicle diagnostics, telematics, monitoring, configuring, and reprogramming are provided. The system, method and computer program product may use an on-board computer, an application-service-provider(ASP)-model application server, and a wireless communication system and framework to provide value-added services to vehicle owners, users, and support organizations. The on-board computer or unit (OBU) may connect with a vehicle bus and provide the application server with read/write access to vehicle data. The OBU may contain software and hardware that may be extensible, lightweight, and modular, allowing for over-the-air enhancement of existing applications and installation of new applications. Application features may be delivered as “primitives” or “core services” (i.e., fundamental instructions and/or statements or operations), which can be used by multiple applications. The OBU software may encapsulate various routines and other software instructions to access and program proprietary and freely accessible vehicle parameters. The OBU software and hardware may include logic to address safe parameter programming according to one or more vehicle controller manufacturer's requirements (e.g., requiring the vehicle to be in an ignition on, engine off state before programming a parameter). The system, method and computer program product may support extensibility of vehicle and other applications, system primitives, core services, communication services, and/or networks, and other control structures, statements, and/or data types.

An application may be the support for a specific vehicle controller, such as a Detroit Diesel Engine Controller (DDEC ECM) or a Meritor Transmission Controller. Applications may encapsulate the key diagnostic knowledge of various parameters along with the behavior of the vehicle controller. The addition of an application may allow data and/or software to be added in either a concentrated or distributed form to the OBU, a system server, and/or a database.

Applications may be the top-level features of the system as seen through the ASP server. Applications may include Leased Vehicle Monitoring, Alerts, Fuel Tax, and Remote Diagnostics (RDA), among others, and a host of other diagnostic and telematic information. The system may allow existing applications to be extended and new applications to be added with minimal impact to the system as a whole. For example, addition of an application may only require changes to the applications located on the OBU if a new capability is required that is not supported by the existing applications.

“System primitives” or “core services” may be the core operations that are carried out between the application server and the OBU, such as a core service entitled “Get Parameter Values,” for example. Each system primitive is designed to be generic, so that new applications do not always require addition of new on-board software to the OBU. For example, the “Get Parameter Values” system primitive or core service may be used to retrieve parameter data for the Remote Diagnostics application, but could be used by future applications that require simple parameter data via request. New system primitives may be needed when new functionality is needed that is not supported by an existing primitive (or combination of existing primitives) or when the use of an existing primitive would be unacceptably expensive in communication costs, for example. The addition of a system primitive may require the addition of software to the OBU and/or the application server.

The system, method, and computer program product are adaptable to support any type of present private and/or public wireless system, and expansion to new alternative communication networks. The addition of a new communication network may require the development of server-side and OBU-side software (and possibly the integration of new hardware into the OBU). The system, method, and computer program product are preferably constructed to handle all known types of wireless communication. Furthermore, the system supports over-the-air updates of the OBU software and configuration. And the OBU software may have capabilities to notify the system of serious events, in the form of software alerts.

b. Generally

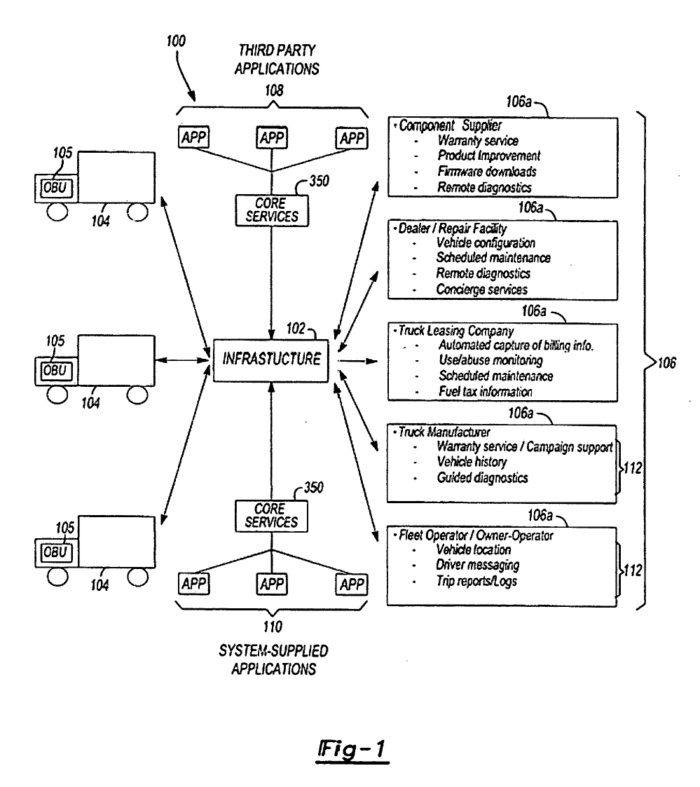

FIG. 1 is a diagram of a vehicle monitoring and diagnostics system 100 according to one embodiment. Generally, the system 100 allows monitoring and control of a vehicle fleet by displaying and controlling data according to a user's specifications. The system 100 is designed with modular applications that interact with core data and services so that vehicle parameters can be monitored, analyzed and displayed in a format that is meaningful to a particular user and/or a particular industry. This flexibility allows different users and/or industries to use the same overall system 100 for vehicle and component monitoring despite their disparate vehicle data requirements.

Referring to FIG. 1, the system 100 may include an application service provider (ASP) infrastructure 102 that acts as a gateway between (i) a plurality of vehicles 104, each vehicle having an associated on-vehicle computer (e.g., an on-board unit or “OBU” 105), and (ii) an interface 106. The interface 106 allows a user or machine 106a to select among various applications, such as third-party applications 108 as well as original, system-supplied applications 110, to obtain and analyze various data from the vehicles 104. The applications may include, for example, tools for obtaining real-time fleet characteristics, trend analysis and diagnostics, to perform manual, dynamic or rule-based configuration, as well as allow fleet managers to provide real-time driver/fleet notification. To ensure that the user receives data that is meaningful to the user's specific application, the user interface 106 can be employed to select and operate one or more of the applications. In the example shown in FIG. 1, different types of users 106a may select different application groups 112 to accommodate their specific data monitoring and reporting needs applicable to their own business.

For example, as illustrated in FIG. 1, a dealer/repair facility may select from the offered applications 108, 110, vehicle configuration, scheduled maintenance, remote diagnostics, and concierge services as its application group 112, while a truck manufacturer may select a different collection of applications 112, such as warranty service/campaign support, vehicle history, and guided diagnostics. By offering a variety of modular applications 108, 110 that can be selected and combined according to the needs of a particular user, the same infrastructure 102 can be employed by different users for different purposes with little or no modification of the infrastructure 102. Further, by allowing users to access third-party applications 108 through the same infrastructure as system-supplied applications 110, the system 100 can leverage services not provided by the system 100, further increasing flexibility and adaptability.

Further, by using an ASP-based model, an application service provider may provide and allow access, on a subscriber basis, to a remote vehicle diagnostics, monitoring, configuration and reprogramming tool via the Internet. That is, the application service provider provides the hardware (e.g., servers, an on-vehicle computer) and software (e.g., database) infrastructure, application software, customer support, and billing mechanism to allow its customers (e.g., fleet managers, vehicle distributors, vehicle dealers, original equipment manufacturers (“OEMs”), leasing/rental companies, and the like) to remotely access the vehicles within a fleet. The tool can be used by subscribers to select and access the modular applications 108, 110.

An ASP-based model can eliminate the need to physically distribute software to users. In such a model, new features and updates can be immediately available to users because the system resides and runs on an application server. In one embodiment, applications that are not on the application server can reside on the OBU 105. The on-board unit applications can be loaded onto the OBU 105 during vehicle installation, and additional applications or application updates can be downloaded onto the OBU 105 through a wireless network connection.

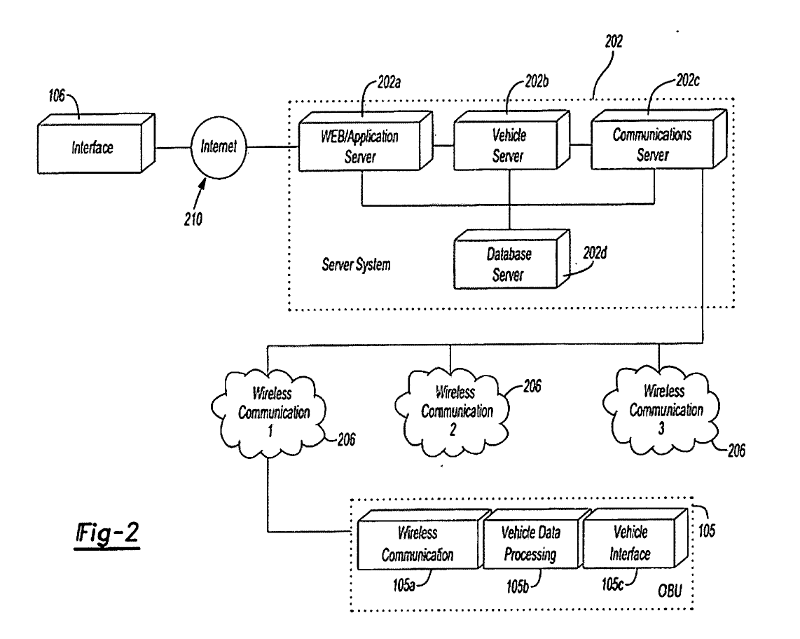

FIG. 2 is a block diagram of a system architecture 200 according to one embodiment. The system architecture 200 shown in FIG. 2 is one possible way for carrying out the functionalities described above and shown in FIG. 1. In this example, the system architecture 200 includes three primary components: the interface 106, a server 202, and the on-board unit (OBU) 105. All three components 106, 202, 105 are designed to communicate with each other through any known means, such as via wireless networks 206.

The wireless networks 206 may be any combination of cellular wireless networks, wireless wide-area networks (wireless WANs), or wireless local-area networks (wireless LANs). The wireless networks 206 may use any wireless communication protocol, such as CDMA, CDMA2000®, TDMA, AMPS, 3G, Bluetooth®, 802.11x, etc. In one embodiment, the system 100 may use the a radio modem, such as a RIM 803D, for connecting to the Motient USA terrestrial network using transport middleware, which may be provided by WirelessCar and/or Aether Systems. As described in more detail below, a wireless subsystem of the system 100 may provide for reliable delivery of messages with store-and-forward capabilities when, for example, a vehicle 104 is out of a coverage area of the wireless networks 206.

The interface 106 can be, for example, a user interface and/or a machine interface that allows a human or machine to access the infrastructure 102, which includes the server 202. The server 202 may include, for example, a series of servers that perform web page hosting, run applications, perform data storage, and/or perform wireless communications network management. In this example, the server 202 includes a web/application server 202a, a vehicle server 202b, and a communications server 202c, all of which are linked to a database server 202d. As shown in the Figure, the server 202 acts as a link between a web based client (user) 106 with the OBU 105, allowing user access and control to a vehicle data stream via the Internet 210 or other internetworking system.

The OBU 105 accesses the data from various vehicle components and may also generate vehicle data of its own to provide to the server 202. The OBU 105 may include a wireless communication module 105a to provide a communication link to a wireless network, a vehicle data processing module 105b to process data obtained from the vehicle components, and a vehicle interface 105c connected to, for example, the vehicle data bus to gather data from the vehicle components for processing and managing time-critical or process-critical functions with the vehicle systems, such as electronic control units. The OBU 105 may also include a global positioning system and a driver display interface. Each of the system architecture components will be described in greater detail below.

c. Components
i. Interface

The interface 106 may be a standard browser interface and/or a machine-to-machine interface. In the browser interface, a human user accesses the system via a standard web browser. In one embodiment, the user gains access to the specific set of their authorized vehicles and functions after login-and-password authorization. In a machine-to-machine interface, server and vehicle data and functions may be accessible via a secure application program interface (API). A machine-to-machine interface allows other applications access to the system 100's capabilities so that the applications can gain remote access to the vehicle and to the capabilities offered by the system. This allows the system 100 to interface with existing or planned back-office applications and operations, making the system 100 suitable for integration with, for example, overall fleet operations or other systems. In one embodiment, the interface 106 may be a B2B client.
ii. Server

The server system is the fixed-based component of the system 100, and as explained above, can be an Internet-based system and use an ASP model. The end user can access the system 100 from the interface 106, such as any commercially available web browser. As noted above, the server 202 in this embodiment includes the web/application server 202a, the vehicle server 202b, the communications server 202c, and the database server 202d. Each of these will be described in greater detail below.

The web/application server 202a contains logic defining one or more applications to an end user. All the data needed for a specific user application is sent to and received from the OBU 105 via the wireless communication network 206. As will be explained in greater detail below, applications perform the necessary calculations and then package the results for presentation in a defined format to the user. Further, web/application server 202a is responsible for running business applications related to user activities, which may include performing business logic, interfacing to the systems databases for fleet, vehicle, component, and transaction activity, knowledge-base storage, and sending user-requested vehicle queries or functions to the vehicle server 202b and the communications server 202c.

The vehicle server 202b in the server 202 stores and processes vehicle-specific data and acts as a translator between the applications 108, 110 and the specific vehicle and/or vehicle component. More particularly, the vehicle server 202b is responsible for processing data requests and vehicle responses, and converting the outbound and inbound data into translated vehicle information.

The vehicle server 202b translates user requests from the interface 106 into formats specific to the vehicle 104 to which the request is directed. The vehicle server 202b conducts this translation without any user interaction or property selections. For example, the vehicle server 202b may evaluate a message being sent to a particular vehicle and detect the vehicle type, the vehicle bus type, and the vehicle component or sub-component that is intended as the message recipient. The vehicle server 202b then packages the message according to the specific communication protocol mandated by the recipient component. As a result, the vehicle server 202b allows monitoring and control of different vehicles having different components through the same interface 106 for a given user and application

As shown in FIG. 2, one embodiment of the system 100 allows communication between at least the OBUs 105 and the server 202 via a wireless network, such as a satellite or terrestrial-based network. A communication server 202c may be included in the server 202 to support wireless communications, and provide a central location for supporting changes and improvements in wireless technology. In one embodiment, the communication server 202c manages the communications activities between the OBU 105 and the vehicle server 202b and processes vehicle/component-specific requests between the OBU 105 and the server 202b.

In one embodiment, the communications server 202c utilizes a wireless communications framework that provides a communication link between the server 202 and the vehicle 104. Although any wireless mobile communication system can be used in the system 100, a flexible wireless communication infrastructure that is capable of handling multiple platforms and/or multiple communication providers is preferred. One possible embodiment of such a framework is described in U.S. Provisional Application No. 60/351,165 (Attorney Docket No. 65855-0060), entitled “Wireless Communication Framework”, filed Jan. 23, 2002, the disclosure of which is incorporated herein by reference in its entirety. To handle multiple communication providers and/or platforms, the flexible wireless communication infrastructure may abstract the needs of a specific wireless communication provider, such as the message size, message format, and specific protocol details, into a standard messaging application program interface (API) understandable by multiple systems and platforms. In one embodiment, the communication server 202c abstracts messages, and stores and forwards messages to ensure later delivery of messages to vehicles that are temporarily outside a wireless communication coverage area, and may even include least-cost routing rules to select among multiple wireless networks to prioritize message routing based on cost and/or criticality of the message.

The server 202 also includes a database server 202d containing relational data tables designed to retain information pertaining to a user, a vehicle, a fleet, system transaction history and other relationships associated with a given vehicle 104. The database server 202d also may be designed to retain the data resulting from any vehicular transaction, such as transactions between the OBU 105 and the server 202. In one embodiment, the database is structured such that authorized users can access vehicles in a number of ways, for example, by fleet ownership, leasing fleet, vehicle manufacturer, and component manufacturer. This structure enables the system 100 to provide each of these beneficiaries with specifically tailored data and access in a format meaningful to each user.

In operation, a user may use a User ID to login to the system 100. This user ID may be unique within the system 100 as a whole, and thus, there may be only one user with a particular user ID. The user ID may determine the role of the user within the system 100, which may be assigned to one or more a plurality of roles, such as user, manager, and administrator. Other roles are possible as well.

The user ID may be associated with a particular vehicle fleet. And in the present context, a vehicle fleet may be a collection of vehicles 104 associated with a single customer and a single billable account and rating plan within a given wireless service provider's billing system. Each vehicle 104, however, may appear in more than one fleet. This allows the system 100 to be used by multiple customers (e.g., OEM, leasing company, fleet) for the same vehicle 104. Because the fleet provides the limit for data visibility, however, data requested from a user within a fleet is only visible to users within the fleet, even if the vehicle is in multiple fleets. This is true both for manually requested data, such as Remote Diagnostic Application (RDA) parameter requests, and for automatic data collection, such as alerts, Leased Vehicle Monitor (LVM), and periodic reporting.

It is possible, however, to define multiple fleets with the same billing account number. All activity on such fleets would be billed on the same invoice against the same rating plan.

A vehicle 104 may be a truck or any other electronically-controlled vehicle. Each vehicle 104 may be configured with at least the following data, which may be the same across all fleets with access to the vehicle 104: VIN, make, model, year, description, an OBU identifier, and components. Components may be the system 100's representation of devices on the vehicle 104, and may include entries for supported vehicle controllers (ECM, transmission, brakes, etc.) and the OBU 105 itself. For each component, at least a serial number and a description may be kept. Within a fleet, each vehicle 104 may be configured with at least a fleet-specific Unit ID for the vehicle 104.

A vehicle 104 may be configured with support for one or more applications. Each application may be the system's support for one or more vehicle controllers 308 (which may be generically known as components). The addition of an application (i.e., vehicle controller support) to a vehicle 104 may require (i) installation of software and configuration information on the OBU 105 and (ii) administrative data entries on the server 202 side. The administrative data may be collected at time of installation and may not be configurable by the user.

A vehicle group is a named collection of vehicles 104 within a fleet. A vehicle 104 in a fleet can be in multiple groups. (Since a vehicle 104 can be in multiple fleets, it follows that one vehicle 104 may be in multiple groups in multiple fleets.) The end user (subject to the user's specific permissions) may be able to create, edit, and delete vehicle groups. Vehicle groups may be used as a standard mechanism in the system as a means for specifying a set of vehicles 104 to which a requested operation may apply.
iii. On Board Unit (OBU)

As noted above, the OBU 105 may provide the vehicle-side, real-time computing base for the system. In one embodiment, the OBU 105 is responsible for data-stream processing, discrete measurements, vehicle-position information, wireless communications, and real-time analysis of data. Within the system's overall framework, the OBU 105 acts as a vehicle server, providing vehicle-specific data and functionality. In one embodiment, the OBU 105 may be an expandable custom hardware platform designed and manufactured to reside on a wide variety of vehicles with different component specifications and needs and is capable of running multiple applications while acting as a vehicle data gateway for others.

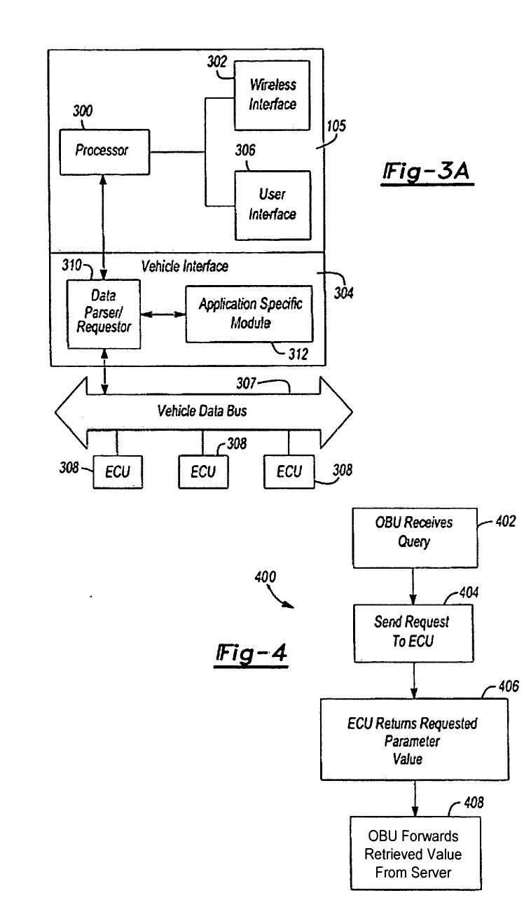

FIGS. 3A and 3B are representative high-level block diagrams of the OBU 105. One embodiment of the OBU 105 may include a data processor 300 and one or more interfaces 302, 304, 306 such as a wireless interface 302 that controls communication between the OBU 105 and the server 202 via the wireless network 206, a vehicle interface 304 that allows the OBU 105 to transmit data to and receive data from, for example, electronic control units (ECUs), vehicle controllers, and/or other vehicle components 308, and an optional user interface 306 that allows a user to read information from and/or enter information into the OBU 105.

The wireless interface 302 in one embodiment sends data to and receives data from the server 202, and abstracts communications from different wireless network devices to allow the OBU 105 to communicate with a flexible wireless communication infrastructure, such as the type described above with respect to the server 202. More particularly, the wireless interface 302 may encapsulate protocol differences among various wireless network devices to provide a standard output to the processor 300. In one embodiment, wireless network messages are routed from the server 202 to the wireless interface 302 for error checking and filtering. After filtering, commands are passed to the processor 300 and then routed to their respective vehicle components. To be compatible with wireless networks, 206, wireless interface 302 may be equipped to communicate over any type of wireless network, such as cellular wireless networks, wireless wide-area networks (Wireless WANs), or wireless local-area networks (Wireless LANs). The wireless interface 302 may use any wireless communication protocols, such as CDMA, CDMA2000®, TDMA, AMPS, 3G, Bluetooth®, 802.11x, etc.

The processor 300 acts as the central processing unit (CPU) of the OBU 105 by managing the sending and receiving of requests between the server 202 and the vehicle 104 via the wireless interface 302. In one embodiment, the processor 300 has the logic and intelligence to carry out vehicle-specific services such as diagnostic requests and processing. For example, the processor 300 may run specific applications that are loaded into the memories 315, 316, 318 or the OBU 105 and that coordinate activities between the vehicle data stream, GPS unit, wireless communications, and the remote server 202. Further, in one embodiment, the processor 300 can be updated through the wireless network to add to and enhance its functionality. This capability eliminates the requirement that the vehicle be at the service bay for software updates, which enhance features and functionality.

The vehicle interface 304 allows the OBU 105 to support a wide variety of vehicle components and subcomponents. Possible interfaces that can be supported by the OBU include SAE J1708, SAE J1939, SAE OBDII, CAN, ISO-9141, discrete I/O, proprietary interfaces, and other interfaces (e.g., discrete or instrumentation interfaces). Further, the vehicle interface 304 provides a single point of contact for all vehicle components and control devices on the vehicle 104, allowing the communication between OBU 105 software and the vehicle's data bus 307 as well as wireless communication devices, such as a satellite-based communications system.

In one embodiment, the vehicle interface 304 may include a data parser/requester module 310 that contains logic, e.g., software code, that is responsible for handling direct interfacing between the processor 300 and the vehicle data bus 307 for non-application-specific (i.e., “generic” SAE J1708 or SAE1939 discrete measurement points) parameter readings, alerts, configuration or reprogramming data, as explained in greater detail below.

The vehicle interface 304 may also include, for example, one or more application-specific modules 312, such as one for each manufacturer-specific controller 308 within vehicle 104, each containing logic that is responsible for handling interfacing between the processor 300 and the vehicle data bus 307 (via data parser/requestor module 310 in this example) for application-specific parameter readings, alerts, and configuration or reprogramming data. Any application-specific module 312 may contain logic pertaining to one or more controller 308, and one or more application-specific modules 312 may contain logic pertaining to the same controller or controllers 308.

Note that the OBU 105 may act as a server and/or data gateway for an application that places data directly on the vehicle data bus 307. In one embodiment, the OBU 105 uses an interface standard, such as TMC RP 1210A, as an element of the data gateway. Regardless of the specific standard used, any activity using the OBU 105 as a data gateway may involve data going through the processor 300.

In an embodiment, the OBU 105 is designed to be compliant with the SAB's Joint SAE/TMC Recommended Environmental Practices for Electronic Equipment Design (Heavy-Duty Trucks), Document No. J1455 (August 1994) standard, which is incorporated herein by reference in its entirety, because it will be a component included (or installed) within vehicles 104. As indicated above, the OBU 105 is not limited to be compliant with any particular standard and can accommodate any on-board electronic system standard (e.g., SAE J1708, SAE J1939, SAE J1850, ISO 9141, proprietary data streams, etc.) for any sub-system (e.g., engines, transmissions, braking systems, instrument clusters, etc.) as long as the system 100 is capable of converting commands between the interface 106 and the OBU 105 according to whichever standard is used by a given vehicle electronic system. If the vehicle electronic system uses a proprietary standard, for example, the vehicle server 202b and the associated application-specific module 312 on the OBU 105 may be adapted to accommodate the proprietary standard.

FIG. 3B illustrates another embodiment of the OBU 105 and explicitly shows the capability to interface with other devices via, for example, a parallel interface, a serial interface, a universal serial bus (USB) interface, a satellite interface, a terrestrial wireless (e.g., 802.11b) interface, and/or a global positioning system (GPS) interface. More particularly, the embodiment of the OBU 105 shown in FIG. 3B includes a GPS circuit 313 that receives signals from a GPS antenna, and a serial interface 314 that communicates with a driver interface or other on-vehicle devices (not shown) such as a handheld device, a cellular telephone, voice messaging system, data logger, or other devices. Serial interface 314 may comply with the well-known RS232/EIA232 standard for serial communication.

FIG. 3B also illustrates a flash memory 315, a dynamic random access memory 316, and an optional compact flash memory 318 coupled to the processor 300 and to a power supply 320, which is coupled to the vehicle battery and ignition switch (not shown). Those of skill in the art will understand that the elements and concepts shown in FIGS. 3A, 3B can be combined in any manner.

The application software and the application framework are built with both a software and hardware abstraction layer. This approach makes the framework adaptable to a number of alternative operating system and hardware platforms. One embodiment of the OBU 105 may use any known real-time operating system.

2. System Operation Examples

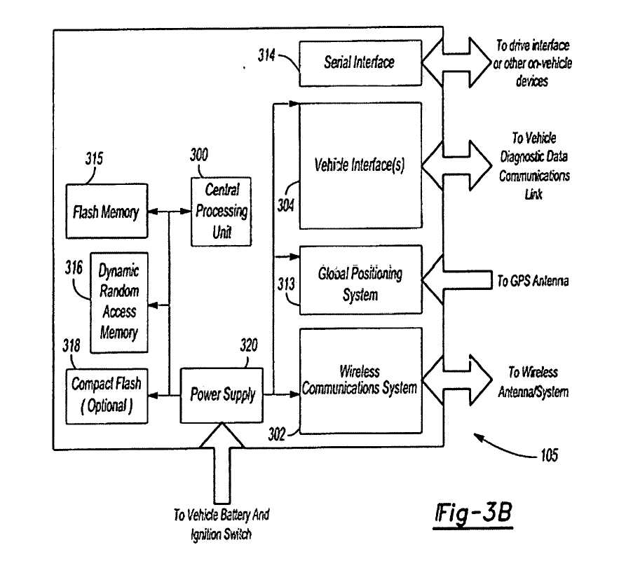

The overall system 100 can support many possible services and applications, examples of which are described below and illustrated in FIGS. 4 through 11. As noted above, the system 100 shown in FIGS. 1 and 2 illustrates one possible relationship between services and applications for a system 100 using an ASP-based model. In one embodiment, a group of core services 350 that perform vehicle-specific operations are available to the applications 108, 110. As noted above, the applications 108, 110 allow a user to tailor the interpretation and display of the vehicle-specific operations to the user's own requirements. The core services 350 act as building blocks of services that can be selected or combined in any desired manner, and can be accessed by or with any applications 108, 110 in the system 100; in other words, the applications 108, 110 act as a functional layer over the more primitive core services 350. For example, the core services 350 may be accessed by a help desk application to obtain vehicle location and parametric data, or by a service application to obtain parametric data and to perform functional tests. Because the system 100 can leverage other applications and services that the system 100 itself may not have and couple them with its own applications and services, the system 100 provides a flexible and adaptable platform that can accommodate many different needs.

In one embodiment, the applications may assemble the core services to perform specific functions. For example, one of the core services 350 may (i) capture measured values and/or (ii) change parameters or operational settings in the vehicle 104, while the applications 108, 110 organize and process information from the core services 350 into groupings that are meaningful to a given user. A service outlet, for example, may want different data and/or data organized in a different manner than would, say, a leasing organization or a component manufacturer.

As noted above and as shown in FIGS. 1 and 2, the interface 106 can be a browser interface or graphical user interface (GUI) that allows a human user to access the system 100, or a machine-to-machine application programming interface (API). The user interface 106 allows the system 100 to act as a gateway between the user and the vehicle(s) 104 via the applications and services. As noted above, the core services 350 provided by the system 100 act as building blocks that can be assembled by applications in a variety of ways to best serve the user. Possible core services 350 may include:
Parameters: obtains discrete or data-stream-based vehicle parameters, including standard and proprietary messages, upon user request;
Alerts: notification of the occurrence of a particular event (e.g., receipt of a trouble code or a notification of a parameter having a value outside an acceptable range);
Functions: runs functional tests on vehicle components and generates result reports;
Configuration: performs remote configuration of a vehicle or component by, for example, changing one or more vehicle parameters;
Reprogramming: performs complete reprogramming, or “re-flashing” of a selected on-vehicle controller;
Geographic location: provides vehicle location through, for example, a GPS system.

This list of core services 350 is not meant to be exhaustive, but simply gives examples of possible services that can be available directly to users or supplied to applications for further processing. Note that, although the explanations below focus on obtaining data from a vehicle ECU 308, the system and functions described below are applicable for any vehicle data.

The “Parameters” service may include a simple parameter retrieval service as well as more sophisticated parameter retrieval services that address limitations in obtaining vehicle data when, for example, the vehicle is turned off FIG. 4 illustrates one simple process 400 for obtaining a parameter. When the OBU 105 receives a command from the server 202 to retrieve a data value at block 402, the OBU 105 sends a query message to the ECU 308 to obtain the ECU's current reading at block 404. Once the ECU 308 returns a parameter value at block 406, the OBU 105 retrieves the value and forwards it to the server at block 408. Note that frequently used parameters may be packaged and transmitted to the server 202 as a single message as a more efficient way of transferring data. Further, the specific means for getting a particular data item may depend on the specific requirements of a given ECU 308. For example, as is known in the art, data points corresponding to an anti-lock brake system may be obtained in a different manner than data corresponding to engine coolant temperature.

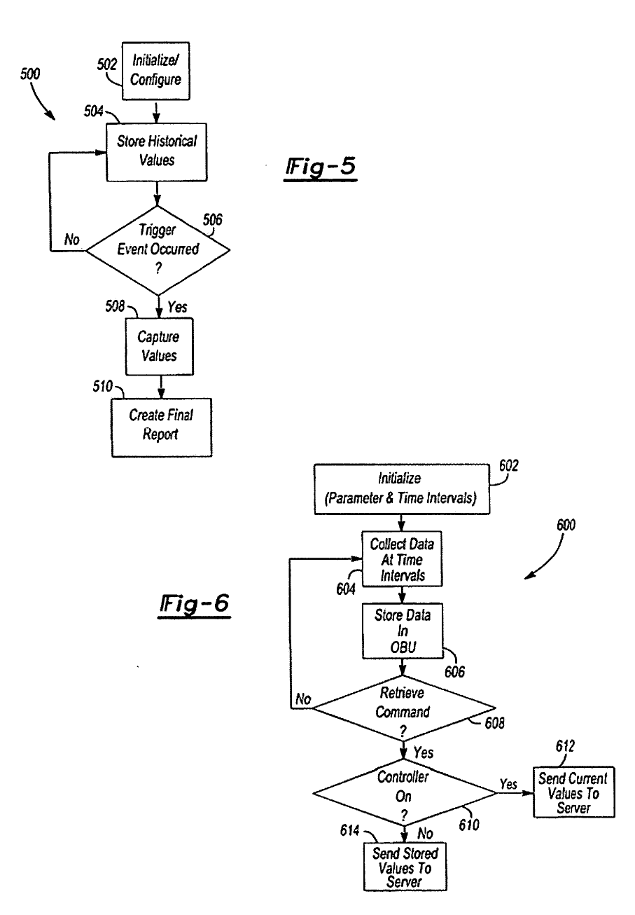

FIG. 5 is a flowchart illustrating one possible process to be offered as a “Parameters” service that is more sophisticated that the simple parameter retrieval service explained above. Although parameter data can simply be read from the vehicle's electronic controllers and provided to the user on demand, the “Parameters” service can also provide more sophisticated parameter data capture methods such as the type shown in FIG. 5. FIG. 5 illustrates a “snapshot” process 500 for obtaining a set of parameter values over a period of time, where the reporting of the parameter values is triggered by a specified event. Offering this service as an on-vehicle diagnostic tool is helpful for intermittent fault diagnosis and vehicle performance analysis. Further, gathering data sets at prescribed periodic intervals minimizes negative effects caused by inherent problems in wireless communication systems, such communications drop-out and lack of coverage, which would normally make remote diagnostics ineffective.

To carry out the snapshot process 500, the system 100 first initializes at block 502 by, for example, storing the diagnostic parameters to monitor, setting the time intervals at which parameter values are captured, selecting the number of captured values to be included in a single report, and selecting the event that will trigger reporting of the captured values. This information can be inputted into the OBU 105 via the interface 106. The parameter values to be captured can be any parameters accessible on the vehicle's electronic controllers by means of a diagnostic data stream or from discrete inputs on the OBU 105. The triggering event can be any non-continuous event that is monitored on the vehicle, such as the capture of an active trouble code from a vehicle controller or a parameter moving outside an established acceptable range.

Once the OBU 105 has been configured (block 502), the OBU 105 maintains a number of historical value sets at block 504 by caching a selected number of parameter readings during normal vehicle operation. While the OBU 105 captures the parameter readings, it also waits for the triggering event to occur. Once the trigger event occurs (block 506), the OBU 105 continues caching the configured parameter readings occurring after the event (block 508). The number of historical value sets can be, for example, half the number of captures to be included in the final report, while the number of value sets taken after the triggering event can make up the other half. Note that, in another embodiment, the OBU 105 may capture parameter readings only before or only after the triggering event, or capture any number of values before and/or after the event.

After all of the desired value sets have been captured and collected, all of the captured readings, both before and after the event, are combined into a final report at block 510. The report can be stored on the OBU 105 for later retrieval or sent via wireless connection to the application server 202a for immediate viewing.

Another possible process that can be offered as a “Parameters” service is a “get stored values” (GSV) process 600, as illustrated in FIG. 6, for collecting parameter values from a vehicle even if the vehicle is unable to provide current parameter values at the time of the query. The GSV process 600 addresses a situation where the vehicle controllers 308 are unable to respond to a query by the OBU 105 (e.g., while the vehicle is turned off). This process is particularly useful in applications requiring remote retrieval of time-sensitive data, such as an odometer reading at the end of a scheduled period, or in any application where the vehicle operating state is unknown at the time of the query.

For the GSV process 600 to be effective, the OBU 105 should be designed to allow continuous remote access so that the OBU 105 is always ready for receiving and sending messages. The OBU 105 is initialized by receiving an instruction to periodically collect specified parameter data at a selected query time interval (block 602). After receiving this command, the OBU 105 will periodically collect data at the specified query time intervals (block 604). The values gathered by the OBU 105 are stored in the on-board unit's memory, such as a flash memory, at block 606 before the OBU 105 is shut down when the vehicle 104 is turned off.

If the OBU 105 receives a GSV “retrieve” command from the application server 202a (block 608), the OBU 105 checks the state of the vehicle controller 308 at block 610. If the vehicle controller 308 is accessible, then the OBU 105 collects the current values from the vehicle controller 308 at that time and sends the collected current values to the server 202 (block 612). If the vehicle controller 308 is not available at the time of the command (e.g., if the vehicle is turned off), making the current values of the controller 308 irretrievable, the saved values in the OBU 105 are sent back to the server 202 as the retrieved values (block 614).

By periodically collecting data at selected intervals while the vehicle controller is operational, the OBU 105 can at least obtain recent vehicle controller parameter readings before the controller 308 is inaccessible at some later time. As a result, the GSV process 600 allows the remote server 202 to obtain the most recent controller data if current data is not available at the time of the query. In short, the GSV process 600 returns the last known value in memory to the server 202 if the vehicle is turned on and will retrieve a backup value, which may still be the last known value in memory, if the vehicle is turned off.

Multiple “Alerts” services may also be provided as a core service in the system 100. In its simplest form, the “Alert” service monitors vehicle trouble codes and transmits a message to the OBU 105 when the trouble code occurs. For example, a fault code may come as solicited or unsolicited, depending on how the controller 308 in the OBU 105 is instructed to handle faults. To obtain an unsolicited fault, the OBU 105 monitors the vehicle data bus 307 for the occurrence of a fault and notifies the server 202 if a fault occurs. If only a set of individual faults are monitored, additional parsing shall be performed to filter out unwanted faults. For example, if a user only wishes to be informed of fault codes corresponding to a component breakdown, as opposed to being informed of all fault codes, the user can indicate this preference via the interface 106.

To obtain a solicited fault, the user may set up periodic queries to the OBU processor 300 in addition to setup notification. Note that the response message may match the message template even if no fault actually existed; in this case, additional parsing of the response message may be necessary to obtain useful information. For example, if the user solicits a request for information, the user may obtain a response based upon the criteria of that request, which may be different than the criteria for unsolicited notifications.

If desired, the “Alert” service may include additional functions such as providing the ability to add/remove individual faults, canceling the alert function for a given fault when a fault alert is fired so that only the first fault occurrence (and not subsequent fault occurrences) trigger a notification message, or configuring the “Alert” service to be stored permanently in, for example, the database server 202d until the user removes the service or until the service is cancelled by a fault occurrence.

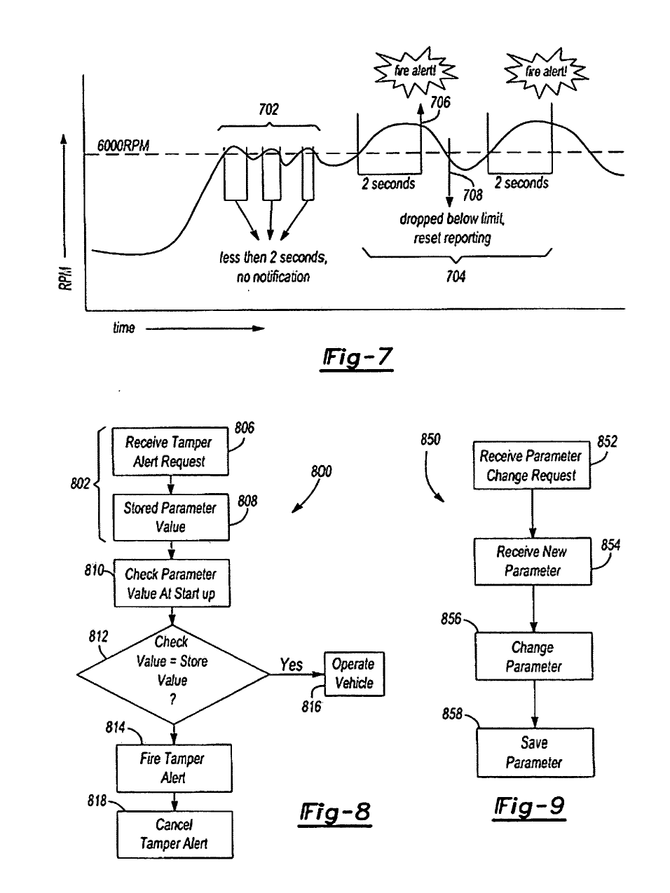

With respect to the example shown in FIG. 7, and as noted above, the “Alerts” service may include among its functions the detection of a particular event by checking whether a monitored value exceeds a selected threshold. Note that, although this example focuses on one diagnostic parameter, any number of diagnostic parameters may be combined into an algorithm to detect threshold-limit boundaries. Further, values may be monitored over time, rather than as single alert-triggering events, to monitor patterns and trends, and detect events more accurately.

As an example of an “Alert” service that monitors over time, FIG. 7 shows an “Over RPM” threshold alert example that detects whether a driver is abusing a vehicle engine. In this example, the Over RPM threshold alert considers the amount of time that the RPM level exceeds a specified limit (6000 RPM in this example) rather than simply generating an alert each time the RPM exceeds the level. The time component ensures that alerts are generated only for events that may cause genuine concern.

As shown in FIG. 7, if the RPM exceeds 6000 for a brief period (e.g., less than 2 seconds) (at 702), the “Alert” service does not generate an alert. However, if the RPM exceeds 6000 for more than two seconds (at 704), the service fires an alert (at 706) and resets itself (at 708) when the RPM drops back below 6000. The actual circuitry for monitoring RPM and implementing this example of an “Alert” service in the system 100 (e.g., on the OBU 105) is well within the skill of those in the art. Further, the time-component concept shown in FIG. 7 can be used for any parameter where undesirable operation is detected with respect to both time and value thresholds.

The “Alert” services may also include a tamper alert feature, as shown in FIG. 8, which allows the user to monitor any unauthorized alteration of configurable parameters. This feature 800 contains a setup process 802, and steps 806 and 808. When a user requests the tamper alert service (block 806), OBU 105 captures the value of the parameter at the time of the request and saves the parameter value to a file in the OBU's memory (e.g., flash memory 315 or DRAM 316) at block 808. Note that this parameter retrieval process may involve using the “Parameters” service as explained above to query the ECU or other vehicle controller or component 308.

The actual tamper check process is conducted when, for example, the vehicle is initially turned on. At this point, the OBU 105 checks the parameter again to get its current value at the time the vehicle ignition is turned on (block 810). If the current value is different than the saved value (block 812), a tamper alert message will be returned to the user (block 814). If the compared values are the same at block 812, however, the vehicle continues operation as usual without transmitting any tamper alert signal (block 816). In one embodiment, the user may add/remove individual tamper alerts, and the tamper alert may be cancelled at block 818 once the alert is fired.

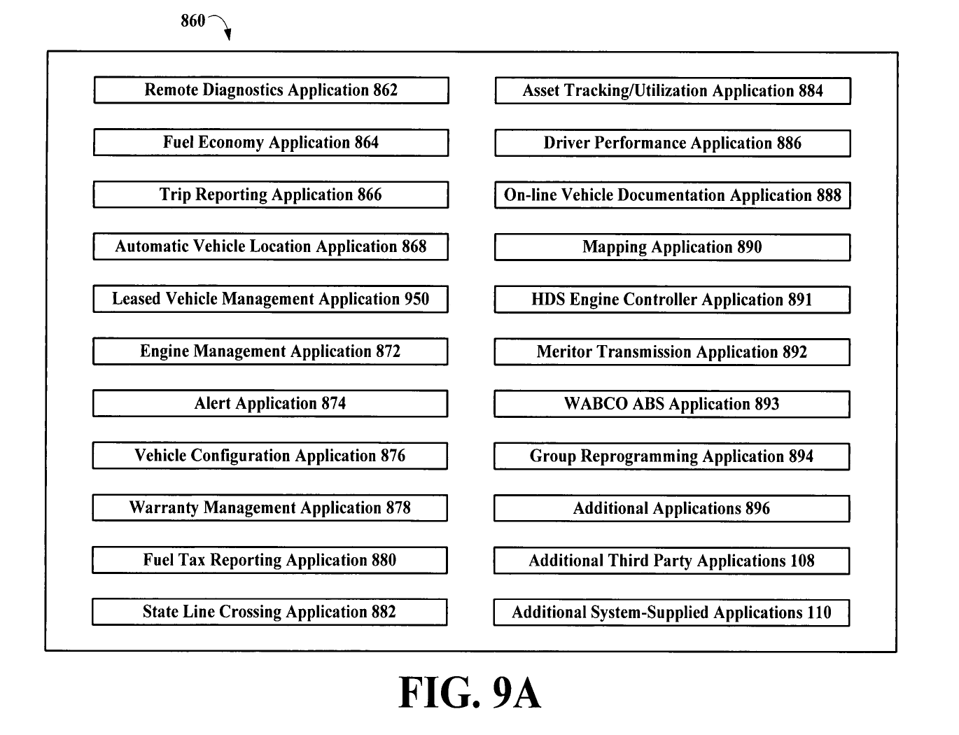

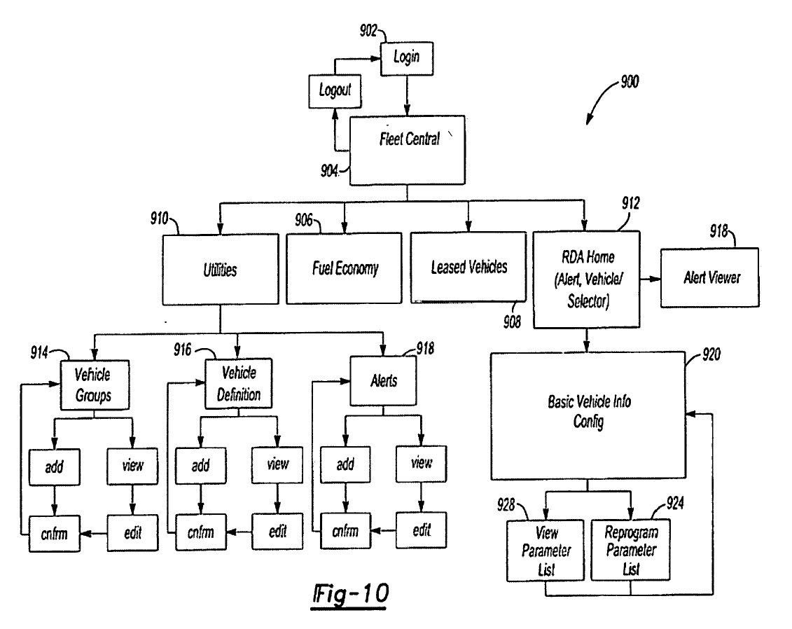

A “Change Parameters” function may also be included as part of a configuration core service, as shown in FIG. 9. This feature may allow a user to remotely insert or update, for example, a parameter or message definition in the vehicle. As shown in FIG. 9, the function 850 includes receiving a parameter change request (block 852), receiving the specific parameter to be changed in the vehicle (block 854), changing the parameter (block 856), and saving the parameter in memory (block 858). In one embodiment, the updated parameter definitions are stored permanently in memory until the next change request. Further, in one embodiment, the updated definition takes effect as soon as the update is completed. The core services can be accessed by one or more applications, as noted above. The system 100 may include the ability to leverage other services that it may or may not have, such as, Fuel Tax Reporting/State Line Crossing applications, Asset tracking/utilization programs, Driver Performance applications, On-line Vehicle Documentation, detailed mapping applications, etc. This flexibility, coupled with modular services and applications 108, 110 that can be added, subtracted, and combined at will, provides for a very flexible and adaptable platform.

3. Applications

a. Generally

FIG. 9A is a block diagram of an exemplary application suite 860 that may be employed in connection with the system 100. Application suite 860 may reside on the ASP infrastructure 102. For example, application suite 860 may reside on the server 202, the web/application server 202a, and/or perhaps on the database server 202d. In one embodiment, application suite 860 is a collection of executable files, each expressed in machine-readable code, residing on a storage medium, such as a hard drive in server 202.

As described above, the system 100 allows users to tailor their use of the remote vehicle diagnostics, telematics, monitoring, configuring, and reprogramming system to their own specialized needs by selecting from among and a plurality of applications in a modular fashion. The applications in application suite 860 may include a Remote Diagnostics Application (RDA) 862, a Fuel Economy Application 864, a Trip Reporting Application 866, an Automatic Vehicle Location Application 868 (based upon GPS or satellite-based system information), a Leased Vehicle Management (LVM) Application 950, an Engine Management Application 872, an Alert Application 874, a Vehicle Configuration Application 876, a Warranty Management Application 878, a Fuel Tax Reporting Application 880, a State Line Crossing Application 882, an Asset Tracking/Utilization Application 884, a Driver Performance Application 886, an On-line Vehicle Documentation Application 888, a Mapping Application 890, an HDS Engine Controller Application 891, a Meritor Transmission Application 892, a WABCO ABS Application 893, a Group Reprogramming Application 894, and others. Application suite 860 also contains data storage for the addition of one or more Additional Applications 896, such as any Additional Third Party Applications 108 or System-Supplied Applications 110. The applications described herein are exemplary, and are not meant to be limiting or comprehensive in any manner. Those of skill in the art will understand that other applications may also be included as possible application options, and that application suite 860 may include any number of applications, well below or far beyond the number shown in FIG. 9A.

b. Remote Diagnostics Application (RDA)

Remote Diagnostics Application 862, for example, provides the ability to perform component analysis before or during a vehicle breakdown and allows vehicle maintenance locations to receive parametric information from a vehicle prior to its arrival, or prior to dispatching a technician to the vehicle. Further, RDA 862 allows a technician to perform selected diagnostic tests on the vehicle or system, with the test process being managed by the OBU 105.

In one embodiment, RDA 862 allows a user to view parameters, active and inactive fault codes, and vehicle configurations, for example, and may also allow authorized users to perform functional tests and configuration changes on the vehicle. RDA 862 may be initiated when, for example, a vehicle notifies the fleet based upon a series of established alerts or when the diagnostics are requested manually by a fleet authorized user.

In practice, the application may provide diagnostic applications via the system 100. When the user logs on to the system 100 via the interface 106, for example, he or she may be presented with a list of vehicles that have reported alerts or notifications that may need attention. If no alerts are active, the user is provided a list of vehicles for which he or she is responsible. At this point the user may elect to use a remote diagnostics application, such as RDA 862 described herein and shown at 912 in FIG. 10, to perform further analysis on the vehicle to determine the severity of the problem.

FIG. 10 is a block diagram illustrating a possible web site architecture 900 that includes RDA 862. In this example, a user may log into the application (block 902) to reach an application home page 904. From the home page, the user may access a range of information, such as fuel economy 906 or leased vehicle information 908, or access utilities 910 or a remote diagnostics application (RDA) page 912 (which would access RDA 862) to monitor, diagnose, and/or reprogram vehicle parameters. In this example, the utilities 910 allow the user to define and/or modify vehicle groups 914, vehicle definitions 916, and alerts 918. The RDA page 912 provides users with access to, for example, vehicle information and parameters 920, including pages that allowing reprogramming 924 and parameter viewing 928. Note that other architectures and implementations are possible for this application as well as other applications.

As described above, Remote Diagnostics Application (RDA) 862 may provide an over-the-air version of diagnostic functions traditionally performed using handheld or PC-based diagnostics tools. One such RDA is described in “Requirements and High Level Design for the Remote Diagnostics Application, Revision 21,” dated Apr. 12, 2002, which is incorporated herein by reference in its entirety. RDA operations may be performed with individual vehicles, rather than vehicle groups, though it is within the ability of those of skill in the art to program system 100 to perform such operations with respect to vehicle groups.

For each application on a vehicle 104 for which RDA support is enabled, one or more “read-only” and/or one or more programmable parameter lists may be accessible. Each parameter list may be limited to a set number of parameters (such as 8) to, for example, (i) provide reasonable GUI display and/or (ii) accommodate maximum wireless message sizes when requesting a set of parameters multiple times. The web application may display, via user interface 106, a history of prior parameter fetches (e.g., date/time and values) for a parameter list. Any number of prior readings may be displayed. Some options for the user may include being able to request that the system 100 “Get Parameters Once” or “Get Parameters M times N seconds apart” (e.g., where M and N are perhaps in the range 1-10). This may result in a request being sent to the vehicle 104.

If the vehicle 104 does not respond in a few minutes (user-specified, e.g., 1-30 minutes) the system 100 may allow the request to timeout and subsequent requests to be issued. The timeout may prevent the user from issuing multiple redundant requests. The system 100 may attempt, however, to fulfill each request even after the timeout has expired. If the user performs a “Get Parameters Once” command and ignition is off, the OBU 105 may return N/A or zero values. Alternatively, an LVM task (such as task 973 described below) may be active, and the OBU 105 may return valid data. If the user performs a “Get Parameters Multiple Times” command and the ignition is off, the request may time out with no values reported.

With respect to reprogramming parameters 924 on the vehicle 104 using the system 100, each vehicle controller 308 may have a “Safe State” requirement, i.e., that the vehicle must be in a known condition before the OBU 105 can attempt the programming operation. The safe state behavior may be defined by particular applications and may require that, for example, the vehicle ignition be on with the engine not running. If the vehicle 104 is not in a safe state when a command is received, the OBU 105 may notify the server 202 that the operation is “Waiting for Safe State.” This status may be displayed on the requesting user's web page.

Safe state may not occur by chance in a reasonable period of time. To guarantee that programming 924 is attempted, it may be necessary to coordinate with an operator of vehicle 104 to put the vehicle in a safe state. Programming requests may or may not support timeout or cancellation. In such case, a new request cannot be issued if there is a prior outstanding request from the same user. If multiple programming requests are issued to program a vehicle controller 308 (e.g., by different users), the order of execution may be random, or system 100 may be designed to accord priority based on, for example, user security or a first-come-first-serve basis.

The RDA 862 may include an Active/Inactive Trouble Code Review feature, which may allow the user to query a vehicle controller 308 for all current Diagnostic Trouble Codes (DTCs). The web application (via user interface 106) may display the most recently retrieved set of DTCs. The user may be able to request that the latest codes be retrieved, which may send a request message from server 202 to OBU 105 via wireless network 206. This feature may require that the RDA 862 include vehicle-specific information.

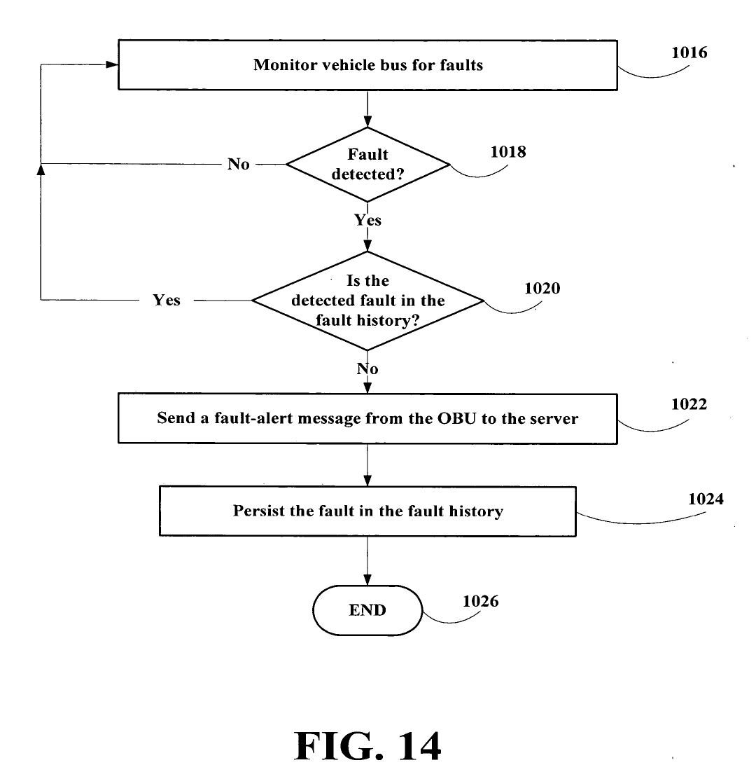

The RDA 862 may also include a “clear codes” feature, which may allow a user to send a command to the vehicle controller 308 to “forget” inactive trouble codes. This action may also reset a fault alert history filter, described in connection with FIG. 14, for the controller 308. The clear codes feature may also be able to be issued for all supported controllers 308 on the vehicle 104. The clear codes operation may have the same safe-state requirements described above. The web application (via user interface 106) may display the status “Waiting for Safe State” if a clear codes operation is the last RDA operation commanded for the vehicle. This feature may require that the RDA 862 include vehicle-specific information.

c. Leased Vehicle Management (LVM) Application

Leased Vehicle Management (LVM) Application 950 is another possible option to generate periodic status reports summarizing selected parameters for each vehicle in a fleet, such as total vehicle distance, total idle fuel, total idle time, total fuel used, and/or total fuel economy.

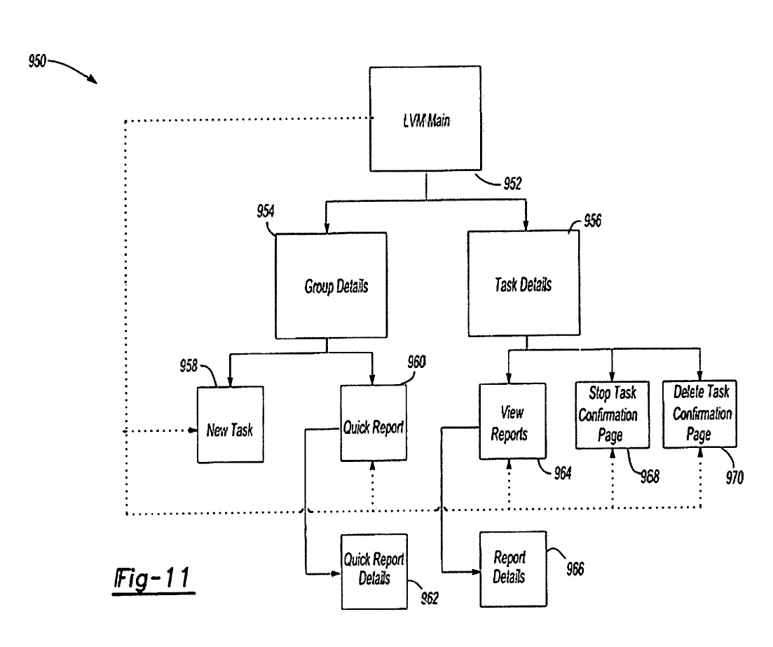

FIG. 11 is a block diagram illustrating a possible architecture for LVM Application 950. In this example, the user reaches a main page 952 that allows the user to choose between a group details page 954 and a task details page 956. Group details 954 correspond to all information for a selected vehicle group, while task details 956 correspond to all information for a selected task. The group details page 954 may allow the user to, for example, create new tasks (e.g., the timing of data collection for a selected vehicle group) 958, generate a report list 960, or generate more detailed reports specifying, for example, parameter values for a selected report 962. The task details page includes similar options, allowing the user to view reports for a selected task 964 and generate more detailed reports 966. The task details page 956 also allows a user to stop a task 968 or delete a task 970.

d. Engine Management Application

Engine Management Application 872 may also be an option to target fleets whose vehicles encounter varying road and traffic conditions, and varying load types and weights. The objective of Engine Management Application 872 may be to improve overall fleet fuel economy via dynamic control of a vehicle's operational characteristics, in particular, horsepower ratings and maximum road speed limits. Traditionally such operating parameters have been established once at a fleet wide level, not taking into consideration some of the variables listed above. In addition, making these changes required physical contact with the vehicle, necessitating undesirable vehicle downtime.

Dynamic adjustments based upon operating conditions can provide reductions in vehicle operational costs, thus resulting in significant savings at a fleet level. With this application the user will be able to dynamically configure the vehicle wherever it may be; tailoring its operational characteristics based upon route, load, and other vehicle operation factors. Engine Management Application 872 may include both measured and programmable parameters. Examples of programmable parameters include Vehicle Road Speed Limit, Engine Horsepower/Torque, Engine Idle Shutdown Time and Cruise Control Settings.

e. Trip Reporting Application

Trip Reporting Application 866 may also be provided as an option. This application allows the fleet manager to obtain trip information from the vehicle on a near-real-time basis. The user can analyze trip information for single vehicles as well as any increment of their fleet. This application primarily uses measured parameters such as odometer readings, total trip fuel, idle fuel, average fuel economy, vehicle route taken, and others. It also uses some parameters to derive data, such as total idle hours and the type of idle hours recorded. The output from this application can also be used as input to the billing systems of leasing companies who charge customers based upon mileage.

f. Alert Application

Alert Application 874 may be a Maintenance Alert Application that allows a fleet manager to establish a series of maintenance triggers based upon key parameters. When a parameter threshold is encountered, the fleet manager will be notified automatically by the system, thus initiating a maintenance event without physical contact with the vehicle. For example, a fleet may establish a preventive maintenance cycle based upon odometer reading. If the server 202 is made aware of the interval, it can notify the fleet of the precise moment when that interval occurs. Alerts may provide notification on parameters such as diagnostic codes, fluid levels and parameter ranges as well as unauthorized tampering with the vehicle.

g. Vehicle Configuration Application

Vehicle Configuration Application 876 may be offered to allow a fleet manager to set certain parameters for multiple vehicles in a fleet so that the selected vehicles will operate within the fleet standards. Examples of parameters include horsepower ratings, maximum road speed limits, maximum and minimum cruise control set speeds and maximum engine idle time before shutdown. Traditionally, this step has required a physical connection of a diagnostic application or tool to the vehicle, but physical connections are time-consuming and require the same step to be repeated on every vehicle that is serviced. The wireless nature of Vehicle Configuration Application 876 allows operational settings and alerts for several vehicles within a fleet at one time by allowing the user to identify selected vehicles, set parameters, and initiate an automated process where each vehicle is systematically configured with the same parameter settings.

h. Warranty Management Application

Warranty Management Application 878 may also be offered as part of a data mining strategy used by, for example, OEMs, to help diagnose warranty relationships between major components or to assess warranty claims for validity. This application would, for example, obtain detailed vehicle data from the database server 202d, using both fleet-specific and system-wide data mining, and then correlate the data with warranty requirements.

i. Alternative Leased Vehicle Management (or Monitoring) (LVM) Application

More than one implementation of a Leased Vehicle Management (or Monitoring) Application is possible. LVM Application 950 was one example, and LVM Application 972 is another. While not shown in FIG. 9A, LVM Application 972 may be stored in application suite 860 at, e.g., Additional Applications 896. LVM Application 972 may perform periodic and on-demand data gathering and reporting. A version of LVM Application 972 is described in “Requirements and High Level Design for the Leased Vehicle Monitoring Application, Revision 9,” dated Mar. 6, 2002, which is incorporated herein by reference in its entirety.

The parameters for LVM Application 972 may include date/time of reading, GPS reading (e.g., last known vehicle location and date/time of that location), odometer (e.g., total vehicle distance), total idle fuel, total idle time, total fuel consumed, and average fuel economy. The computation of average fuel economy may be implemented as PID 185, entitled “Average of instantaneous fuel economy for that segment of vehicle operation of interest,” which is a running average of fuel economy as implemented by an engine manufacturer. The actual source of LVM Application 972 parameters (i.e., mapping from PIDs to the named parameters) may be specific to the Engine Controller Vehicle Application. LVM Application 972 tasks may be set up to run on a periodic or on-demand basis.

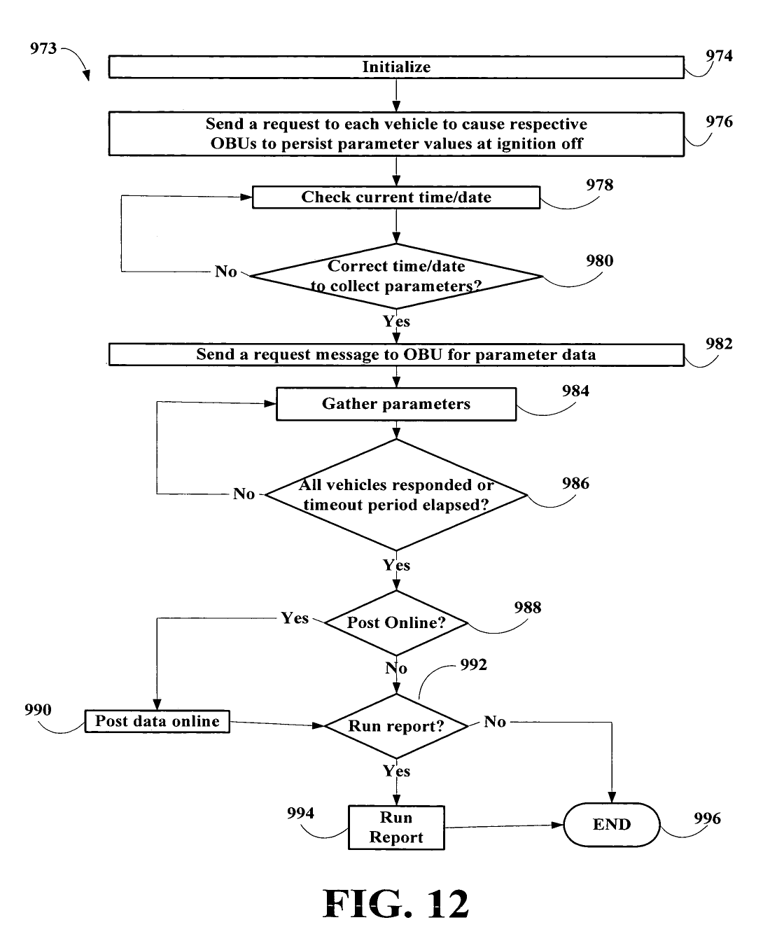

FIG. 12 is a flowchart illustrating a process flow for an LVM Application 972 task 973 that runs on a periodic basis. LVM Application 972 periodic tasks can be setup to run, for example, daily, weekly or monthly. Other periods are possible as well. At block 974, when task 973 is established, an initialization/setup may be run, in which a user selects, via interface 106, certain parameters to be monitored and a time period, specifying how often the parameters are to be gathered. At block 976, the server 202 may send a request to each vehicle 104 in the group to cause each respective OBU 105 to persist the last known values of each parameter at ignition off.

LVM Application 972 may then repeatedly check the current time/date, at block 978, and then determine whether that time/date is the correct time/date to collect parameter data, at block 980. When the scheduled task time arrives, server 202 may then send a single request message to OBU 105 for parameter data, at block 982. LVM Application 972 then repeatedly gathers the parameter data, at block 984, and checks, at block 986, whether all vehicles in the group have responded, or the timeout period has elapsed. The data may be gathered by the OBU 105 wirelessly transmitting the data via wireless networks 206 to server 202. The timeout period may be based on the frequency at which the report is set to run. For example, the timeout period may be 4 hours for a daily report, 12 hours for a weekly report, or 48 hours for a monthly report.

Once LVM Application 972 determines at block 986 that no more data will be collected, the application 972 checks, at block 988, whether the user has opted to view the data online. If so, the data is posted online at block 990. The collected data may then be viewed on-line via interface 106. The application 972 then checks, at block 992, whether the user has opted to have a report run containing the collected data. If so, the report is run at block 994, causing the collected data to be sent to, e.g., a text or HTML file, which is stored in and accessible from server 202. Task 973 then ends at block 996.

Each report may contain entries for data collected for the executed task 973 up until the time of the report. Data received from vehicles 104 reporting later may be viewable via a web page and/or included in another report. The request at block 976, to cause each OBU 105 to persist the last known values of each parameter at ignition off, may be made so that valid values may be returned even if the vehicle 104 is off when the parameter request is received at block 982. Non-applicable (N/A) values can be returned and shown in the report if the OBU 105 has never had the chance to persist these values when the parameter request is received. (Correct values may be returned if the ignition is on when the request is processed.)

The OBU 105 may be requested to persist one or more parameters by one or more tasks. The system 100 would be configured such that cancellation of one task would not result in a loss of the persistence of a parameter being used by other tasks. As stated above, LVM Application 972 tasks may be set up to run on a periodic or on-demand (i.e., “ad-hoc”) basis.

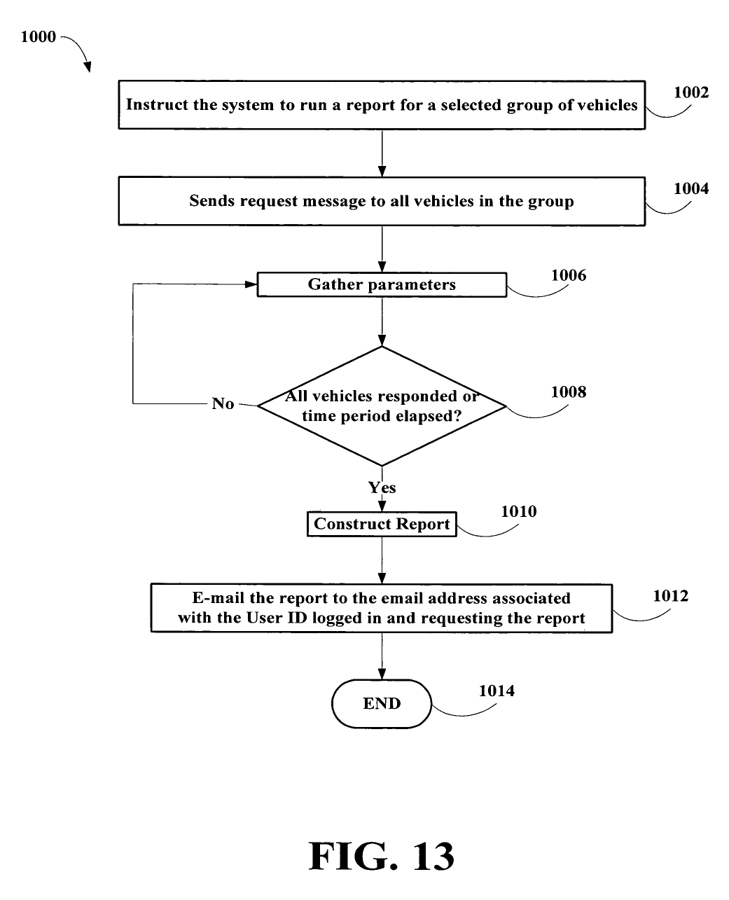

FIG. 13 is a flowchart illustrating a possible architecture for an LVM Application 972 task 1000 that runs on an ad-hoc basis. The task 1000 may also be known as initiating an LVM collection on an ad-hoc basis, or as an “LVM Ping,” or “QuickReport.” The task 1000 may begin when, at block 1002, the user instructs the system 100 (via user interface 106) to run a QuickReport on a selected set of parameters and for a selected group of vehicles. At block 1004, the server 202 may responsively send to OBU 105, via wireless network 206, a single request message to all vehicles in the group.

LVM Application 972 then repeatedly gathers the parameter data, at block 1006, and checks, at block 1008, whether all vehicles in the group have responded, or a given amount of time (e.g., 1 hour) has elapsed. The data may be gathered by the OBU 105 wirelessly transmitting the data via wireless networks 206 to server 202. The timeout period may be set by the system 100, or optionally input by the user via user interface 106. Note that, if a vehicle that is included in a QuickReport request (such as via task 1000) is not part of a group that has a periodic LVM task established, and the ignition is off when the request is received, N/A values (displayed as 0) may be returned.

Once LVM Application 972 determines at block 1008 that no more data will be collected, the application 972 may construct a report, at block 1010. At block 1012, the report may then be emailed to the email address associated with the User ID logged in and requesting the QuickReport via interface 106. Alternatively or additionally, an online posting and report running algorithm such as that found in blocks 988-994 of FIG. 12 may be employed. Finally, the task 1000 ends at block 1014.

LVM requests and reports may be performed against vehicle groups. The customer may setup and configure vehicle groups as desired. When a vehicle 104 is added to a group for which there is a periodic LVM task already setup, the system 100 would be configured to transmit to that vehicle 104 a command to persist LVM parameters when the ignition is turned off, to avoid N/A or zero values being returned to the server 202.

j. Alternative Alert Application

In addition to Alerts services described above with respect to FIGS. 7 and 8, the system 100 may further provide alerts applications, such as Alert Application 874, which may allow the vehicle 104 to be monitored for specific events and cause an “alert” to be generated when these events occur. The system 100 may support fault alerts, tamper alerts, and threshold alerts, all of which are described in more detail below. An exemplary alerts application is described in “Requirements and High Level Design for Alert Application, Revision 111,” dated Mar. 6, 2002, which is incorporated herein by reference in its entirety.

Alert tasks may be established on a vehicle group basis. Each alert task can monitor for one or more alert types. An alert task may be setup to automatically e-mail selected users when an alert is received. Alternatively, an alert task may be setup to periodically write received alerts to a report file that may be accessed from, for example, server 202. Each report may contain alerts received since the last report time. When an alert task is established, a setup message may be sent to each vehicle in the selected group for each alert type for each vehicle controller. The setup message may be established by an alert monitoring application in the OBU 105.

Alert Application 874 may support a simple status tracking on received alerts. Each received alert may be automatically given a status of “Open.” Each alert's status may be able to be changed to, e.g., “Pending” or “Closed.” Alerts may be able to be displayed for a vehicle or group and may be able to be filtered based on specified criteria, such as the type of alert or status of the alert. With each alert, the OBU 105 may collect and transmit to the ASP infrastructure 102 (i) the date and time that the alert was generated and (ii) the last known vehicle location and the date and time the vehicle 104 was at that location.

FIG. 14 is a flowchart illustrating a possible architecture for an application according to one embodiment. As shown in FIG. 14, fault alerts monitored by Alert Application 874 may represent notification that a Diagnostic Trouble Code (DTC) was reported by a vehicle controller 308, such as an ECU 308. At block 1016, the vehicle bus 307 is monitored for DTCs (or “faults”). This continues until a DTC is detected at block 1018. At that point, Alert Application 874 may check a data table or other storage (perhaps on the OBU 105 or on the server 202) known as a fault history, containing recently triggered faults.

At block 1020, if the detected fault is in the fault history, Alert Application 874 merely continues to monitor the vehicle bus 307. If the detected fault is not in the fault history, a fault-alert message may be sent (at block 1022) from the OBU 105 to the server 202 via wireless network 206. After alerting the server 202, the OBU 105 persists the memory of the fault (at block 1024) in the fault history and may not fire that fault alert again until the specific fault has been dropped from the OBU 105's fault history.

This behavior may be designed to limit the wireless cost and notification frequency of intermittent alerts. A fault may be dropped from the OBU 105's fault history when, for example, fault alerting is disabled and subsequently re-enabled on the OBU 105, a “clear codes” command is issued to the vehicle controller 308, or the fault is no longer reported by the vehicle controller 308 at ignition on. Other criteria for dropping a fault may be used as well. The Alert Application then ends at block 1026.

The Alert Application 874 may be programmed to comply with SAE standard J1708 behavior, whereby vehicle controllers (such as ECU 308) remember DTCs that the controllers 308 have reported, even after the actual condition no longer exists. Such DTCs may be flagged as “inactive” by the controller 308. A “clear codes” operation performed using the system 100 or a handheld diagnostic tool may be used to instruct the vehicle controller 308 to no longer remember or store the DTC. The actual faults supported may be specific to the vehicle controllers 308. If a fault is reported by a controller 308 that the Alert Application 874 detects but cannot specifically identify, an alert may be fired with a description such as “undefined.”

Tamper alerts monitored by the Alert Application 874 may represent notification that a monitored parameter on a vehicle controller 308 has changed its value. The functionality of the tamper alerts aspect of Alert Application 874 is substantially as shown in FIG. 8 and described with reference thereto. An application may be created that would access the alerts system primitives or core services, thus allowing access to this functionality via interface 106. The tamper alerts capability of Alert Application 874 is intended to provide notification of cases where programmable parameters on a vehicle controller are modified outside of the normal operation of the system 100.

The set of parameters checked for tampering may be defined per vehicle controller type in, for example, the server 202. The ECUs 308 without programmable parameters might not support tamper alerts. At each ignition on, the OBU may compare the value of each monitored parameter with its value at the prior ignition on. If the values are different, then a tamper alert message may be fired, and the new value may be persisted for the next comparison. No tamper alert is fired if the system 100 is used to change the value of a programmable parameter.

Threshold alerts monitored by Alert Application 874 may represent notification that a monitored value exceeded a user-defined threshold. The functionality of the threshold alerts aspect of Alert Application 874 is substantially as shown in FIG. 7 and described with reference thereto. An application may be created that would access the alerts system primitives or core services, thus allowing access to this functionality via interface 106. The tamper alerts capability of Alert Application 874 may be specific to the vehicle 104, and/or to each ECU 308. The set of alerts may include (i) engine over (user-specified) RPM for more than (user-specified) seconds; (ii) hard braking that results in at least a (user-specified) MPH speed decrease in (user-specified) time (seconds or less); and/or vehicle speed that exceed (user-specified) MPH for more than (user-specified) time (e.g., seconds). A threshold alert may be fired each time the specified condition occurs. Each specific alert type may have its own rules for resetting the condition and becoming eligible to re-fire the alert.

k. Fuel Tax Application

Fuel Tax Application 880 may automate the collection of information for vehicle mileage by jurisdiction to satisfy IFTA or other Fuel Tax filing requirements. An exemplary Fuel Tax application is described in the following documents, which are incorporated herein by reference in their entirety: “Requirements and High Level Design for the Fuel Tax Data Application, Revision 7,” dated Mar. 6, 2002, “eTechnician Fuel Tax Data Collection for Mack—System Overview, Revision 4,” dated Mar. 5, 2002, and “eTechnician Fuel Tax Data Collection for Ruan—System Overview, Revision 1,” dated Jan. 25, 2002.

To satisfy IFTA or other Fuel Tax filing requirements, Fuel Tax Application 880 may be required to collect at least two sets of data: (i) vehicle mileage by jurisdiction (e.g., state/province) and (ii) fuel purchase records/receipts. Note that fuel tax filing may be based on fuel purchased, not necessarily fuel used. It is acceptable to IFTA to satisfy the miles-by-jurisdiction data requirement by collecting frequent GPS position/timestamp reports from the vehicle and an occasional odometer reading. A sampling frequency of 60 minutes is often accepted but sometimes rejected by IFTA auditors. A sampling frequency of 15 or 30 minutes may be acceptable. The GPS location samples may be plotted on highway maps (using tools for mapping/fuel tax/dispatch) and the mileage-by-state calculated from the most likely route. The odometer readings may be compared with calculated distances to check for inconsistencies (if a large difference exists). Alternatively, Fuel Tax Application 880 may prorate the calculated distance against the odometer distance (if a small difference exists). Thus, Fuel Tax Application 880 may automate the collection of miles-by-jurisdiction information.

Fuel Tax Application 880 may collect the following data periodically, (e.g., every 30 minutes): GPS location information and date/time information. Fuel Tax Application 880 may collect the following data once per day at, for example, midnight (local time with respect to the user's time zone): total vehicle distance (based on, e.g., the vehicle odometer), total idle fuel (volume of fuel consumed by vehicle 104 while vehicle 104 was idling), total idling time, and total fuel used. Fuel Tax Application 880 may carry out the data collection using a “Get Parameters” capability for the specified parameters. The on-board software on the OBU 105 that supports Fuel Tax Application 880 persists the data and location values at each ignition off, so data can be reported for the, e.g., midnight readings even if the vehicle is off at midnight.

Fuel Tax Application 880 can be setup to report daily, weekly monthly, or on any other periodic or ad-hoc basis. Reports may be saved to files that can be accessed from, e.g., an file transport protocol (ftp) site and/or from a web application via user interface 106. Each report may contain the data received since the last report ran. Some latency of data is expected even if the vehicles are in coverage. The server 202 may request the latest information from vehicles 104 that have not reported “recently,” i.e., within a specified period of time.

The OBU 105 and vehicle 104 (e.g., a wiring harness of vehicle 104) may be equipped for an optional LED. The LED may light at “ignition on” (which may be a lamp test) and whenever the OBU 105 (via Fuel Tax Application 880) is unable to record Fuel Tax data. The LED is required to be installed for the system to be IFTA compliant. When the LED comes on (other than for a lamp test), this may be a signal indicating that the driver should revert to handwritten driver trip reports as the source of Fuel Tax miles-by-jurisdiction data.

The LED can be lit for a variety of reasons, including (i) briefly at “ignition on” and/or OBU boot/startup (lamp test); (ii) when OBU 105 software detects a loss of GPS data for more than, for example, 10 minutes with the ignition on; (iii) when OBU 105 software is unable to write (record) fuel tax data; (iv) when no fuel tax task (such as Fuel Tax Application 880) is established or installed on OBU 105; (v) when OBU 105 software fails to startup; and/or (vi) when OBU 105 hardware failed to startup. Other reasons are possible as well, and may be coded into Fuel Tax Application 880 by those of skill in the art.

Finally, it is within the skill of those in the art to program Fuel Tax Application 880 to use system 100 to perform fuel tax tasks, such as Fuel Tax Application 880, with respect to vehicle groups, as well as individual vehicles. When a vehicle 104 is added to or deleted from a group for which there is a fuel tax task, such as Fuel Tax Application 880, already setup, the vehicle 104 may automatically receive commands to enable/disable fuel-tax-data collection.

l. Mapping Application

The system 100, specifically via Mapping Application 890 (and perhaps State Line Crossing Application 882), may keep track of the last known location of each vehicle 104. This information may be graphically displayed on user interface 106 as markers on a map for one vehicle 104, or for a vehicle group. Most from-vehicle messages (including those pertaining to other applications) may contain a last-known vehicle location and timestamp, which may be used to update this information for Mapping Application 890. For example, location-and-timestamp information may be returned due to other applications, such as LVM, RDA, etc. Location information may optionally be displayed on user interface 106 as a proximity string, such as “1.3 miles S of Utica, Mich.” A database used to construct this output may contain both large and small population centers. As disclosed above, a GPS receiver and antenna may be installed as a source of position and date/time information.

m. HDS Engine Controller Application

HDS Engine Controller Application 891 may support the public SAE J1708/J1587 parameters and faults for an engine controller. The following standards are hereby incorporated by reference in their entirety: SAE J1708, entitled “Serial Data Communications Between Microcomputer Systems in Heavy-Duty Vehicle Applications,” published October 1993; SAE J1587, entitled “Electronic Data Interchange between Microcomputer Systems in Heavy-Duty Vehicle Applications,” published February 2002; and SAE J1939, entitled “Recommended Practice for Truck and Bus Control and Communications Network,” published August 2003.

n. Meritor Transmission Application

Meritor Transmission Application 892 may support the ZF Meritor FreedomLine Transmission, and is specified in Phase 1 of “Requirements—Enhanced ZF Meritor FreedomLine Transmission Support, Revision 5,” dated Feb. 27, 2002, which is incorporated herein by reference in its entirety.

o. WABCO ABS Application

This vehicle application may support WABCO ABS Application 893, specified in “Requirements and High Level Design for WABCO ABS Vehicle Applications, Revision 1,” dated Jul. 29, 2001, which is incorporated herein by reference in its entirety.

p. Alternative Embodiment of LVM Application 950

An alternative embodiment of the Leased Vehicle Monitor Application (LVM Application 950A) may be stored in application suite 860, and is described in “Requirements and High Level Design for the Leased Vehicle Monitoring Application, Revision 15,” dated May 16, 2002, which is incorporated herein by reference in its entirety.

LVM Application 950A may support a different parameter set per customer (or per fleet). The specific parameter set may be configured in the server 202 database by system administrators. LVM Application 950A for a given fleet may add the following new parameters (which are available only from DDC ECMs): fast idle time, fast idle gallons, driving time, driving gallons, and engine load factor.

In LVM Application 950A, a scheduled report may be run at a specified task time. This report may include an entry for every vehicle 104 in the task's group, regardless of whether new data has been received. A flag in the report may indicate whether or not new data has been received for each vehicle 104 since the report last ran. The LVM Application 950A report may be accessible via user interface 106 from, for example, an ftp site and/or a web interface. A quarterly schedule option is available via LVM Application 950A. The user may choose the month in which the quarter starts, and the report may be generated on the last day of the quarter. Leading up to the scheduled report time, two queries may be sent to each vehicle 104 on a set schedule. As an example, for a daily schedule, a first query may be sent 12 hours before the report is generated, and a second query may be sent 4 hours before the report is generated.

Different schedules may be set for daily, weekly, monthly, and quarterly reporting. This approach allows the report to show recent data even if the vehicle is not in coverage immediately before the report is run. Determining an appropriate query schedule is within the ability of those of skill in the art. The results of each individual query may also be viewed on user interface 106 via the web application. When a vehicle 104 is added to or deleted from a group for which there is a periodic LVM task already setup, the vehicle 104 may automatically receive a command to enable or disable persistence of LVM parameters when the ignition is turned off.

q. Alternative Embodiment of Alert Application 874

An alternative embodiment of the Alert Application 874 (Alert Application 874A) may be stored in application suite 860, and is described in Requirements and High Level Design for Alert Control and Reporting, Revision 13 dated May 1, 2002 11), which is incorporated herein by reference in its entirety. The Alert Application 874A may allow individual control of alerts on each vehicle. To accommodate this, a separation may be made between an alert setup on a vehicle 104 and e-mail/report options for alerts. Accordingly, alert settings may control subscriptions whereby the OBU 105 notifies the server 202 of an alert condition. Alert settings may no longer be “task” based. However, alert monitors may control what happens (email, report) in the system 100 when an alert is received. In one embodiment, within a fleet, each vehicle has its own alert settings. The most recent change to a vehicle's alert settings may set the vehicle's alert settings, which may replace any prior settings.

Alert settings may be enabled, changed or disabled on a vehicle group as well as on individual vehicles. The alert settings may include (i) definition of which alerts are enabled (fault, tamper, threshold) on which vehicle controllers 308, and (ii) definition of the threshold values for threshold alerts. Alert monitors may be “task” based and allow email notification and/or file-based reporting of alerts to be set up on specific vehicle groups and alert types. Alert monitors may be configured to not change alert settings for vehicles (i.e., which alerts are enabled or what thresholds are set) but may define the behavior of the server 202 in response to receiving alert notifications. Multiple alert monitors may be set up on the same vehicle group or on groups with overlapping membership. This may allow multiple notifications to be made based on different vehicle group criteria without additional wireless message traffic beomg sent over the wireless network 206. Differing alert subscriptions may be allowed between different fleets.

When utilizing Alert Application 874A, the system 100 may support Tamper Alerts on more than one controller per vehicle. Furthermore, the HDS and DDC Vehicle Applications may support reporting the “throttle position” (e.g., PID 91: Percent Accelerator Pedal Position—ratio of actual accelerator pedal position to maximum pedal position) with an “overspeed” threshold alert. Throttle position is may be captured at the time the speed threshold is exceeded.

r. Group Reprogramming Application

Group Reprogramming Application 894 may allow parameter changes to be made to multiple vehicles at the same time, and is fully described in “eTechnician Group Reprogramming Requirements and High Level Design, Revision 4,” dated May 24, 2002, which is incorporated herein by reference in its entirety. In this application, group reprogramming may be performed based on vehicle groups. The vehicle group may determine the set of vehicles 104 to which a request is sent from server 202 over wireless networks 206. Subsequent changes to vehicle-group membership may be handled by Group Reprogramming Application 894 by optionally sending the same request to subsequently added vehicles and/or optionally sending perhaps a counteracting request to dropped vehicles. Such programming decisions are within the ability of those of skill in the art.

Group Reprogramming Application 894 supports a set of programmable parameters that may be considered generally useful across multiple vehicles 104 and controller 308 types. The mapping from the server-202-side parameters to specific vehicle controller 308 parameters may be specific to an application specific module 312 on a given OBU 105. These parameters may include vehicle speed limit, cruise speed, cruise enable, and engine horsepower/torque rating.

In operation of Group Reprogramming Application 894, the user may select a vehicle group and certain values to be programmed. When the request is submitted, the parameters with values entered may be included in the wireless request messages transmitted from server 202 to the OBUs 105 via the wireless networks 206. Range checking may be performed at server 202. Additional checking may be performed on the OBU 105, and thus, in some cases a request may fail due to out-of-range parameters. The last-known value for each parameter may be displayed for each vehicle, if available. The server 202 may or may not attempt to optimize out a request if the last-known value matches the new value for a specific vehicle/parameter.

Via user interface 106, the web application may display the status of the last 4 (or some other number) group-reprogramming requests for the selected vehicle group. The user may be able to “drill down” (by navigating through user interface 106) to determine the status of the request for each vehicle 104.

In general, each vehicle controller 308 has a “safe state” requirement as described above with respect to RDA 862. That is, the vehicle must be in a known condition before the OBU 105 will attempt the programming operation. The safe-state behavior may be defined by the Group Reprogramming Application 894, and may take the form of a requirement that the vehicle 104 ignition be on with the engine not running. If the vehicle is not in a safe state when the programming command is received, the OBU 105 may notify the server 202 that the operation is “Waiting for Safe State” and this status may be displayed on the requesting user's web page via user interface 106.

As before, safe state may not occur by chance in a reasonable period of time. To guarantee that programming 924 is attempted, it may be necessary to coordinate with an operator of vehicle 104 to put the vehicle in a safe state. Programming requests may or may not support timeout or cancellation. In such case, a new request cannot be issued if there is a prior outstanding request from the same user. If multiple programming requests are issued to program a vehicle controller 308 (e.g., by different users), the order of execution may be random, or system 100 may be designed to accord priority based on, for example, user security or a first-come-first-serve basis.

As noted above, the possible modular applications described herein are meant as illustrative examples only. Further, as noted above, the applications 108, 110 accessed by the infrastructure 102 can be generated by third parties and offered as modules for incorporating into a particular user's interface 106 and accessing the OBU 105 and other system-supported core services and applications. The modular functionality offered by independent applications 108, 110 allows disparate users to access the same vehicle data via the same OBUs 105 and the same infrastructure 102, but be offered data, functionalities, and interfaces that are meaningful to that user's industry as determined by the particular modular applications selected by the user. The specific manner for implementing the applications via, for example, computer programs, is within the ability of those of skill in the art.

4. Security

With respect to the web application provided to user interface 106 by server 202, specifically web/application server 202a, security may be provided on the ASP infrastructure 102 by using Secure Sockets Layer, or SSL, which is an Internet security protocol designed to provide privacy and encryption in communications, such as communications between a user and the web application. With respect to users, at least three levels of user permissions may be implemented. Each user may be assigned one of the following security levels: fleet user (read-only access), fleet manager (full access to tasks and limited access to vehicle definition), or fleet administrator (full access to vehicle definition and limited access to tasks). The actions that each security level can perform may be defined separately for each application, but in general, only the fleet manager may be permitted to perform actions that cause messages to be sent to the vehicles 104. Other security levels may be implemented within the skill of those in the art.

5. Provisioning

a. Generally

The system 100 may support a Provisioning Automation feature, which may automate two significant aspects of provisioning and deployment of the OBU 105: (i) pre-shipping configuration and provisioning; and (ii) vehicle installation. The Provisioning Automation feature is described in the following documents, which are incorporated herein by reference in their entirety: “Provisioning—Executive Overview, Revision 3,” dated Apr. 18, 2002, and “Provisioning—System & HL Requirements, Revision 6,” dated Feb. 21, 2002.

b. Pre-Shipping Automation

The pre-shipping automation may include (i) loading the OBU 105 with base software, (ii) network activation (via wireless networks 206) (requesting wireless service with, e.g., a combination of WirelessCar, Aether, and Motient), (iii) loading the wireless communications server 202c of the server 202 with communication identity information for the OBU 105, (iv) loading web/application server 202a of server 202 with identity information for the OBU 105, (v) conducting a network test (verify that communications are operational), and (vi) notifying VAS/CCS of the OBU 105's identity.

c. Vehicle Installation

The vehicle installation automation may include (i) identifying vehicle 104 components 308, (ii) collecting vehicle 104 information, (iii) loading vehicle-specific support into the OBU 105, (iv) service activation (e.g., notifying a wireless service provider of the OBU 105/vehicle 104/customer association and initiating the activation fee and customer billing, (v) loading web/application server 202a of server 202 with vehicle information, and (vi) conducting a network test (verify that communications are operational on the vehicle 104).

6. Communications

The system 100 may break the on-board (OBU 105) communications software into small components to facilitate over-the-air updates. This may allow the OBU 105 to control a PowerSave state of a RIM 802 Modem. This may allow the OBU 105 to respond more quickly (e.g., seconds rather than minutes) when, for example, the vehicle 104 is in a wireless coverage area with the ignition on.

7. Billing

The system 100 may use a billing system that allows billing customers on the basis of features used. Billing requirements are documented in “eTechnician Billing Requirements, Revision 5,” dated Apr. 9, 2002, which is incorporated herein by reference in its entirety. In one embodiment, the server 202 may collect usage data and provide it to a wireless service provider. The wireless service provider may process the data against customers' rating plans and send invoices to customers. The billing system may support: (i) a unique rating plan per customer; (ii) an activation fee when service is activated on a vehicle 104; (iii) a monthly service fee per vehicle 104; (iv) a monthly service fee per vehicle 104 per feature, for specified features; (v) for each service type (feature used), an allowance of events (number) and an excess cost of events beyond that allowance; and (vi) multiple customers per vehicle 104 (i.e., a vehicle belongs to multiple fleets, each of which is billed separately).

8. Cummins RoadRelay 4

The system 100 provides support for RoadRelay 4 (RR4), which is a trip recorder and vehicle computer with user interface. This support allows the OBU 105 to interface with an RR4 unit and provide over-the-air access to certain RR4 features. The requirements for this feature set are described in “Phase 1 Requirements—eTechnician Integration with Cummins RoadRelay 4, Revision 4,” dated Dec. 4, 2001, which is incorporated herein by reference in its entirety. The features may include (i) trip data (over-the-air extraction and export of the cdtrip/sstrip trip summary file), (ii) GPS input (providing GPS data to RR4 units that do not have an internal GPS receiver), (iii) position mapping (standard system 100 mapping, such as Mapping Application 890); (iv) faults (using RR4 as a source for ECM faults only, which provides enhanced descriptions); and (v) fleet mode security support (support for basic RR4 security system).

9. Mobitex Communications

The system 100 is capable of communicating using an RIM 902M radio modem over a Mobitex network. Cingular provides United States coverage. The system 100's wireless subsystem may provide for reliable delivery of messages with store-and-forward capability when, for example, the vehicle is out of coverage. Typical round-trip latency for a simple request (server 202 to OBU 105 back to server 202) may be 10 to 30 seconds.

10. Qualcomm Communications

The system 100 is capable of communicating using the Qualcomm OmniTRACS network. This solution (i) may support up to about 400 vehicles 104 (system-100-wide); (ii) maximum message size may be slightly less than 400 bytes (theoretical maximum is slightly less than 1200 bytes); and (iii) may not use date/time or location from Qualcomm network, i.e. the OBU 105 still requires GPS receiver 313. Typical round-trip latency for a simple request (server 202 to OBU 105 back to server 202) may be 2 to 5 minutes. Latency might exceed 18 hours under unusual conditions. The system 100's wireless subsystem (such as wireless networks 206) provides for reliable delivery of messages with store-and-forward capability when the vehicle is out of coverage. The customer may also be required to subscribe to additional Qualcomm features in order to enable messaging for the system 100. Communications between the OBU 105 and the Qualcomm MCT may be via the J1708 bus. A general discussion of Qualcomm communications for the system 100 is provided in “e-Technician over Qualcomm—System Summary, Revision 6,” dated Jun. 25, 2001, which is incorporated herein by reference in its entirety. The specific feature set implemented for Qualcomm is described in “e-Technician over Qualcomm Phase 1—Project Plan, Revision 3,” dated Aug. 2, 2001, which is incorporated herein by reference in its entirety.

11. Canadian Communications

The system supports RIM 802D-based communications in Canada. This support may involve a roaming link between a wireless carrier (such as Motient) in the United States and a wireless carrier (such as Bell Mobility) in Canada. Devices to be supported in Canada or roaming may need to be registered on both the U.S. and Canadian (i.e., Motient and Bell Mobility) networks.

12. Conclusion

The system 100 therefore provides a modular wireless vehicle diagnostics, command, and control system that may be tailored to a user's specifications. More particularly, the modular applications 108, 110 provide versatility and allow users from disparate industries to use the same overall system 100 by selecting the applications 108, 110 relevant to their particular industry. Further, by creating a wireless diagnostics and command and control service, real-time remote access is provided to vehicles and vehicle systems via, for example, the Internet and wireless networks. In one embodiment, users may connect to multiple data points on any given vehicle to interpret and analyze the vehicle data in real time, change vehicle parameters as needed and create historical databases to guide future decisions.

Further, by monitoring vehicle operation in real time and providing user-selected reports for each vehicle, the system achieves heightened efficiency, lowered maintenance costs and downtime, and allows pre-ordering of parts as vehicles approach scheduled maintenance.

Note that the capabilities described above are meant to be illustrative and not limiting. The system 100 can be adapted to, for example, establish a setting that is applied to selected group of vehicles with a single command rather than individually establishing a setting for each vehicle. The aspects of the request, including authorization, vehicle/component differences, password differences, and configuration limitations of the specific request, may be managed by, for example, the server 202. In another embodiment, the system 100 can view each vehicle 104 as a single entity to allow the user to communicate with multiple ECU's on the same vehicle 104 at the same time. For example, data can be obtained from an Engine ECU and Transmission ECU at the same time, with the resultant data from each controller correlated to the other to add more detail to the data offered to the user.

Variations of the system described above are possible without departing from the scope of the claims. For example, selected applications may be run locally on proprietary equipment owned by the customers (i.e., the fleet managers, vehicle distributors, vehicle dealers and the like) as a stand alone software application instead of over the Internet. Further, the OBU 105 can be equipped with, for example, a bar code scanner and/or other human user interface to facilitate data capture. Other user interfaces and functions, such as a handheld diagnostics tool, workflow integration tool, links between data captured by different applications, and tools to provide advance warning of vehicle faults or pre-arrival diagnostics information may also be included as application modules or core services or even integrated within the application modules themselves. Note that one or more additional servers can also be incorporated into the system to, for example, accommodate additional data management functions and/or provide interfaces for integrating with existing applications.

Information obtained via the system 100 can also be used to, for example, re-calibrate vehicle components, perform firmware downloads, perform component failure analysis, determine wear characteristics, analyze quality of components used in manufacturing processes, retrieve and manage warranty information, receive indications of vehicle maintenance needs, monitor vehicle use/abuse, monitor lessee trip information, perform proactive data analysis, and/or perform pre-arrival diagnostics. This list is not exhaustive, and those of skill in the art will understand that other variations in (i) the data obtained via the system 100 and (ii) how the data is presented and used can vary without departing from the scope of the claims.

In the exemplary embodiments described herein include on-board vehicle systems and other vehicle mounted devices may include or be utilized with any appropriate voltage source, such as a battery, an alternator and the like, providing any appropriate voltage, such as about 12 Volts, about 24 Volts, about 42 Volts and the like. Further, the embodiments described herein may be used with any desired system or engine. Those systems or engines may comprises items utilizing fossil fuels, such as gasoline, natural gas, propane and the like, electricity, such as that generated by battery, magneto, solar cell and the like, wind and hybrids or combinations thereof. Those systems or engines may be incorporated into another system, such as an automobile, a truck, a boat or ship, a motorcycle, a generator, an airplane and the like.

In the embodiments described above, the System, Method and Computer Program Product for Remote Vehicle Diagnostics, Telematics, Monitoring, Configuring, and Reprogramming includes computing systems, controllers, and other devices containing processors. These devices may contain at least one Central Processing Unit (“CPU”) and a memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

Although several possible embodiments of an apparatus, system, and method have been described, various changes and modifications may be made or suggested by those skilled in the art without departing from the spirit or scope of the following claims.

1. A system for remote vehicle diagnostics, telematics, monitoring, configuring, and reprogramming, comprising:
an on-board unit disposed on at least one vehicle to send and receive data corresponding to at least one vehicle operating characteristic;
an application-service-provider infrastructure;
an application suite located on the application-service-provider infrastructure, comprising at least one modular application, each of the at least one modular applications having an associated function that processes said data obtained via the on-board unit; and
an interface for selecting from the application suite at least one of the modular applications that will use the associated function to diagnose, monitor, configure, reprogram, and/or obtain telematic information from the at least one vehicle.

2. The system of claim 1, wherein the on-board unit comprises:
at least one on-board unit interface to support communication between the on-board unit and at least one device outside the on-board unit;
a processor that manages the data sent and received by the on-board unit via said at least one interface; and
a memory coupled to the processor.

3. The system of claim 2, wherein said at least one on-board unit interface comprises at least one interface selected from the group consisting of:
a wireless interface that supports communication with a wireless communication system;
a vehicle interface that supports communication with at least one vehicle component via a vehicle data bus;
a user interface that supports communication with a user;
a serial interface that supports communication with at least one of a driver interface and an on-vehicle device; and
a global positioning interface that supports communication with a global positioning system (GPS) device.

4. The system of claim 3, wherein the vehicle interface comprises at least one interface selected from the group consisting of:
a data parser/requester module that handles non-application-specific interfacing between the processor and the vehicle data bus; and
an application specific module coupled to the data parser/requester module that handles application-specific interfacing between the processor and the vehicle data bus.

5. The system of claim 1, wherein the modular applications comprise at least one application selected from the group consisting of third-party applications, system-supplied applications, and core services.

6. The system of claim 1, wherein the interface comprises at least one interface selected from the group consisting of:
a user interface that supports interaction with a human user; and
a machine-to-machine interface.

7. The system of claim 6, wherein the user interface is a graphical user interface.

8. The system of claim 1, further comprising a server linking the on-board unit to the interface via the modular applications.

9. The system of claim 8, wherein the server comprises at least one server selected from the group consisting of:
a web/application server containing logic defining the modular applications;
a vehicle server that acts as a translator between the modular applications and the on-board unit;
a communications server to support communication via a wireless network; and
a database server containing at least one relational data table retaining information associated with the vehicle.

10. The system of claim 1, wherein at least one of the plurality of modular applications correlates data between at least two vehicle controllers on the same vehicle.

11. The system of claim 1, wherein at least one of the plurality of modular applications establishes a setting for a plurality of vehicles with one command sent via the interface.

12. The system of claim 1, wherein the at least one modular application comprises at least one application selected from the group consisting of a remote diagnostics application, a fuel economy application, a trip reporting application, an automatic vehicle location application, a leased vehicle management application, an engine management application, an alert application, a vehicle configuration application, a warranty management application, a fuel tax reporting application, a state line crossing application, an asset tracking/utilization application, a driver performance application, an on-line vehicle documentation application, a mapping application, an HDS engine controller application, a Meritor transmission application, a WABCO ABS application, and a group reprogramming application.

13. A method for remote vehicle diagnostics, telematics, monitoring, configuring, and reprogramming, comprising:
obtaining data from an on-board unit disposed on at least one vehicle corresponding to at least one vehicle operating characteristic;
providing an application-service-provider infrastructure;
providing an application suite located on the application-service-provider infrastructure, comprising at least one modular application, wherein each of the at least one modular applications has an associated function that processes said data obtained via the on-board unit; and
selecting, via an interface, at least one of the modular applications from the application suite to process, using the associated function, the data obtained from the on-board unit to diagnose, monitor, configure, reprogram, and/or obtain telematic information from the at least one vehicle.

14. The method of claim 13, wherein the on-board unit comprises:
at least one on-board unit interface to support communication between the on-board unit and at least one device outside the on-board unit;
a processor that manages the data sent and received by the on-board unit via said at least one interface; and
a memory coupled to the processor.

15. The method of claim 14, wherein said at least one on-board unit interface comprises at least one interface selected from the group consisting of:
a wireless interface that supports communication with a wireless communication system;
a vehicle interface that supports communication with at least one vehicle component via a vehicle data bus;
a user interface that supports communication with a user;
a serial interface that supports communication with at least one of a driver interface and an on-vehicle device; and
a global positioning interface that supports communication with a global positioning system (GPS) device.

16. The method of claim 15, wherein the vehicle interface comprises at least one interface selected from the group consisting of:
a data parser/requester module that handles non-application-specific interfacing between the processor and the vehicle data bus; and
an application specific module coupled to the data parser/requester module that handles application-specific interfacing between the processor and the vehicle data bus.

17. The method of claim 13, wherein the modular applications comprise at least one application selected from the group consisting of third-party applications, system-supplied applications, and core services.

18. The method of claim 13, wherein the interface comprises at least one interface selected from the group consisting of:
a user interface that supports interaction with a human user; and
a machine-to-machine interface.

19. The method of claim 18, wherein the user interface is a graphical user interface.

20. The method of claim 13, further comprising a server linking the onboard unit to the interface via the modular applications.

21. The method of claim 20, wherein the server comprises at least one server selected from the group consisting of:
a web/application server containing logic defining the modular applications;
a vehicle server that acts as a translator between the modular applications and the on-board unit;
a communications server to support communication via a wireless network; and
a database server containing at least one relational data table retaining information associated with the vehicle.

22. The method of claim 13, wherein at least one of the plurality of modular applications correlates data between at least two vehicle controllers on the same vehicle.

23. The method of claim 13, wherein at least one of the plurality of modular applications establishes a setting for a plurality of vehicles with one command sent via the interface.

24. The method of claim 13, wherein selecting at least one of the modular applications comprises selecting at least one modular application from the group consisting of a remote diagnostics application, a fuel economy application, a trip reporting application, an automatic vehicle location application, a leased vehicle management application, an engine management application, an alert application, a vehicle configuration application, a warranty management application, a fuel tax reporting application, a state line crossing application, an asset tracking/utilization application, a driver performance application, an on-line vehicle documentation application, a mapping application, an HDS engine controller application, a Meritor transmission application, a WABCO ABS application, and a group reprogramming application.

25. The method of claim 13, further comprising:
sending a first request message to each of the at least one vehicle to cause the on-board units disposed thereon to persist parameter values at ignition off;
sending a second request message to said on-board units at a scheduled time;
gathering parameter data in said on-board units in response to said second request message until either all vehicles in the group respond or a timeout period elapses;
posting said parameter data online if requested by a user; and
sending said parameter data to a report if requested by a user.

26. The method of claim 13, further comprising:
initiating a report for a selected group of vehicles;
sending a request message to all vehicles in the group;
gathering parameter data in said on-board units in response to said request message until either all vehicles in the group respond or a timeout period elapses;
constructing a report reflecting said parameter data; and
sending the report to an e-mail address.

27. The method of claim 13, further comprising:
monitoring a vehicle bus for faults;
detecting a fault;
determining whether the fault is stored in a fault history;
sending a fault-alert message from the on-board unit to the application-service-provider infrastructure if the fault is not stored in the fault history; and
persisting the fault in the fault history.

28. A computer program product comprising a computer usable medium having control logic stored therein for causing a computer to provide remote vehicle diagnostics, telematics, monitoring, configuring, and reprogramming, comprising:
first computer readable program code means for causing an on-board unit disposed on at least one vehicle to send and receive data corresponding to at least one vehicle operating characteristic;
second computer readable program code means for providing an application suite located on an application-service-provider infrastructure, comprising at least one modular application, each of the at least one modular applications having an associated function that processes said data obtained via the on-board unit; and
third computer readable program code means for providing an interface for selecting from the application suite at least one of the modular applications that will use the associated function to diagnose, monitor, configure, reprogram, and/or obtain telematic information from the at least one vehicle.

29. The computer program product of claim 28, wherein the on-board unit includes:
at least one on-board unit interface to support communication between the on-board unit and at least one device outside the on-board unit;
a processor that manages the data sent and received by the on-board unit via said at least one interface; and
a memory coupled to the processor.

30. The computer program product of claim 29, wherein said at least one on-board unit interface comprises at least one interface selected from the group consisting of:
a wireless interface that supports communication with a wireless communication system;
a vehicle interface that supports communication with at least one vehicle component via a vehicle data bus;
a user interface that supports communication with a user;
a serial interface that supports communication with at least one of a driver interface and an on-vehicle device; and
a global positioning interface that supports communication with a global positioning system (GPS) device.

31. The computer program product of claim 30, wherein the vehicle interface comprises at least one interface selected from the group consisting of:
a data parser/requester module that handles non-application-specific interfacing between the processor and the vehicle data bus; and
an application specific module coupled to the data parser/requester module that handles application-specific interfacing between the processor and the vehicle data bus.

32. The computer program product of claim 28, wherein the modular applications comprise at least one application selected from the group consisting of third-party applications, system-supplied applications, and core services.

33. The computer program product of claim 28, wherein the interface comprises at least one interface selected from the group consisting of:
a user interface that supports interaction with a human user; and
a machine-to-machine interface.

34. The computer program product of claim 33, wherein the user interface is a graphical user interface.

35. The computer program product of claim 28, further comprising a server linking the on-board unit to the interface via the modular applications.

36. The computer program product of claim 35, wherein the server comprises at least one server selected of the group consisting of:
a web/application server containing logic defining the modular applications;
a vehicle server that acts as a translator between the modular applications and the on-board unit;
a communications server to support communication via a wireless network; and
a database server containing at least one relational data table retaining information associated with the vehicle.

37. The computer program product of claim 28, wherein at least one of the plurality of modular applications correlates data between at least two vehicle controllers on the same vehicle.

38. The computer program product of claim 28, wherein at least one of the plurality of modular applications establishes a setting for a plurality of vehicles with one command sent via the interface.

39. The computer program product of claim 28, wherein the at least one modular application comprises at least one application selected from the group consisting of a remote diagnostics application, a fuel economy application, a trip reporting application, an automatic vehicle location application, a leased vehicle management application, an engine management application, an alert application, a vehicle configuration application, a warranty management application, a fuel tax reporting application, a state line crossing application, an asset tracking/utilization application, a driver performance application, an on-line vehicle documentation application, a mapping application, an HDS engine controller application, a Meritor transmission application, a WABCO ABS application, and a group reprogramming application.
